(19) United States
(12) Patent Application Publication
(10) Pub. No.: US 2024/0034177 A1
(43) Pub. Date: Feb. 1, 2024

(54) SMART CHARGE SCHEDULING FOR AN AGGREGATE OF ELECTRIC VEHICLES CONSIDERING GRID DEMAND

(71) Applicants: Ford Global Technologies, LLC, Dearborn, MI (US); The Ohio State Innovation Foundation, Columbus, OH (US)

(72) Inventors: David McCreadie, Ann Arbor, MI (US); Ryan O'Gorman, Beverly Hills, MI (US); Devang Bhalchandra Dave, Ann Arbor, MI (US); Farshad Harirchi, Ann Arbor, MI (US); Abhishek Gupta, Columbus, OH (US); Shiping Shao, Dearborn, MI (US); Hossein Sartipizadeh, Canton, MI (US)

(21) Appl. No.: 18/224,473

(22) Filed: Jul. 20, 2023

Related U.S. Application Data
(60) Provisional application No. 63/390,779, filed on Jul. 20, 2022.

(51) Int. Cl. B60L 53/63; H02J 7/00; B60L 53/62; B60L 53/67; B60L 53/64

(52) U.S. Cl. CPC B60L 53/63; H02J 7/0071; B60L 53/62; H02J 7/0048; B60L 53/67; B60L 53/64

(57) ABSTRACT

A system and method for controlling charging of multiple electric vehicles (EVs) arriving at, and departing from, different charging stations at different times, includes scheduling charging of each EV of the multiple EVs responsive to which one of a plurality of categories each EV is assigned, each EV being assigned to one of the categories according to an arrival time at an associated one of the different charging stations, a departure time from the associated one of the different charging stations, an initial state of charge (SoC) of the EV, and a target SoC of the EV, and controlling charging of each EV responsive to the scheduling of charging for the assigned category of each EV. Charging demand may be selected by each EV as being reliable or flexible with flexible charging demand having a minimum target SoC and maximum target SoC.

### CROSS-REFERENCE TO RELATED APPLICATIONS

This application claims the benefit under 35 U.S.C. § 119(e) of U.S. Application 63/390,779 filed Jul. 20, 2022, the disclosure of which is hereby incorporated by reference in its entirety.

### TECHNICAL FIELD

This disclosure relates to controlling charging of individual electric vehicles (EVs) based on charge scheduling considering vehicle settings in addition to aggregate electric demand and cost of electric grid power.

### BACKGROUND

An ongoing shift toward electrification and the adoption of EVs has raised concern among electric utility companies with respect to the large loads of energy drawn from the grid for sustained periods of time to charge these vehicles. Charging demands from EVs (averaging around 16 kWh/EV/day) can strain the electric grid such that utility companies are implementing various demand management strategies. EV sales in the United States alone increased by 85% from 2020 to 2021 according to the US Department of Energy. This rapid growth poses challenges both charging service providers (charging platforms) and the grid operators as a large-scale EV charging market leads to a highly random and significant load to the power grid. This problem can be mitigated by: 1) ramping up and down the energy output generated by dispatchable power plants (which generally uses non-renewable sources of energy); or 2) scheduling the charging of EVs by a platform to coordinate with the grid operators and renewable energy providers. The former approach requires significant capital investment in building new infrastructure. On the other hand, the latter approach is more straightforward to implement due to the inherent flexibility of the EV charging process and widespread availability of smart chargers. For example, charging one EV may take up to two hours, but the customer may park the EV in a charging station overnight, allowing for slower, delayed, or preemptive charging. Furthermore, customers may opt for a flexible charging service that allows the charging provider to charge the EV between a minimum target SoC and a maximum target SoC.

Scheduling algorithms for EV charging have been developed under various assumptions and with specific goals. Typically, in a day-ahead market, the platform has complete information about the future demand, and thus, the charging process can be scheduled offline by a deterministic algorithm. For instance, various algorithms have been developed to solve valley-filling problems that shave the difference between the charging loads and grid capacity. Another set of algorithms optimize the profits/costs/social-welfare of charging through a deterministic optimization. Other strategies employ game theoretic approaches.

However, current algorithms either do not exploit information that are available from past data or are too computationally complex to be able to schedule a large number of EVs. For instance, online algorithms that schedule according to a departure deadline or laxity of charging, i.e. Early Deadline First (EDF) and Least Laxity First (LLF) algorithms, do not incorporate the information of future demand that can be inferred from past data, and thus, are sub-optimal in many scenarios.

If the distribution of the future demand is known, then the charging platform can apply Model Predictive Control (MPC), scenario-based algorithms, or other stochastic optimization methods to optimize the charging schedule. For instance, MPC has been used to maximize charging profits for each EV or to track a specified demand trajectory. Nonetheless, these algorithms schedule the charging processes either with an integer programming or using the dynamics for individual EVs. This leads to an increase in the computational complexity (potentially exponentially) as the number of EVs grows in the market and corresponding challenges to real-time implementation in a large-scale EV charging market. This intractability is also present in recently proposed data-driven reinforcement learning based scheduling algorithms due to the very high number of past samples needed for learning an approximately optimal policy.

In addition to the limitation stated above, these algorithms consider single types of demand. The multi-type demand strategies mainly focus on the types or levels of charging rates among the EVs. For instance, Bayram et. al. applied a multi-class queue network to model the charging services with different charging rates. The goal is to optimize the quality of the service and the charging cost by tuning the prices of charging that affect the demand rate. Kong et. al. also used the queue network framework to allocate appropriate chargers to different types of EVs. Khalkhali et. al. proposed a two-stage algorithm that schedules EV charging with slow/fast charging services to minimize the expected charging costs.

### SUMMARY

The present inventors have recognized that controlling charging of EVs with a focus on multiple types of flexibility of charging demand benefits both the customers and the charging platform in that the customers can choose a lower charging price in exchange for platform flexibility of not charging to their specified target SoC. This provides the platform more flexibility to drop the aggregated charging demand during the peak-hours, which can reduce the charging costs to the platform. As such, in one or more embodiments according to the disclosure, control of charging individual EVs is performed based on preemptive scheduling of charging a large number of EVs with electric grid services using a stochastic dynamic program with a state-dependent action constraint.

In one or more embodiments, control of charging an aggregate of EVs is based on use of approximate dynamic programming (ADP) to compute a scheduling algorithm for the charging of the EVs that maximizes the profit of the EV charging platform. This algorithm facilitates a mix of inflexible and flexible charging demand types employing a multi-stage algorithm that efficiently solves the high dimensional scheduling problem, along with the complexity and optimality analysis. Each EV that arrives at a charging station is assigned a category depending on its arrival/departure time and initial/target state of charge (SoC). This categorization allows scheduling and control of the charging process for a large number (on the order of millions) of EVs because the computation complexity depends only on the number of the categories, rather than the number of EVs. In addition, the system and method allow the customer to specify a flexible charging demand with a minimum target SoC and a maximum target SoC. While this additional flexibility adds an extra dimension in the state and action space that would otherwise lead to at least O(L²) time complexity where L is the number of classes, various embodiments employ a multi-stage algorithm that sequentially solves the scheduling problem to reduce complexity to O(L) time complexity. The sufficient condition for the multi-stage algorithm to be optimal is also described.

Embodiments may include a method for controlling charging of multiple electric vehicles (EVs) arriving at, and departing from, different charging stations at different times, comprising, by one or more processors: scheduling charging of each EV of the multiple EVs responsive to which one of a plurality of categories each EV is assigned, each EV assigned to one of the categories according to an arrival time at an associated one of the different charging stations, a departure time from the associated one of the different charging stations, an initial state of charge (SoC) of the EV, and a target SoC of the EV; and controlling charging of each EV responsive to the scheduling of charging for the assigned category of each EV. The method may further include assigning each EV to one of the categories according to one of a plurality of charging demand types designated by the EV. The plurality of charging demand types may include a reliable charging demand and a flexible charging demand. For EVs designating the flexible charging demand, the scheduling may be responsive to a specified minimum target SoC and a specified maximum target SoC of the EV.

In various embodiments, scheduling charging of each EV includes scheduling charging of EVs designating the reliable charging demand assuming the EVs designating the reliable charging demand will consume all available electricity during a specified time period based on an associated grid upper demand band for the specified period, and scheduling charging of EVs designating the flexible charging demand based on the specified minimum target SoC of the EVs designated the flexible charging demand. Scheduling charging of each EV may also include allocating available electricity from an electrical grid to each of the plurality of categories based on a number of EVs in each category arriving at the charging stations during a designated time period and a cost associated with allocated available electricity, the allocated available electricity limited by a minimum of remaining electricity available for each category and charging capacity of the multiple EVs. In various embodiments, the cost associated with the allocated available electricity corresponds to a net cost corresponding to cost of electricity supplied by an electric grid less a cost associated with a penalty corresponding to the allocated available electricity corresponding to EVs designating the reliable charging demand being insufficient to charge the EVs designating the reliable charging demand to associated target SoCs. The cost associated with the allocated available electricity may correspond to a net cost corresponding to cost of electricity supplied by an electric grid less a cost associated with a penalty corresponding to the allocated available electricity corresponding to EVs designating the flexible charging demand being insufficient to charge the EVs designating the reliable charging demand to associated minimum target SoCs.

In at least one embodiment, scheduling charging of each EV includes determining a number of EVs in each category designating a reliable charging demand and arriving at a specified time using a designated statistical distribution, allocating electricity from the grid available for charging to each category designating the reliable charging demand for a second specified time period, associating electricity cost of electricity allocated to each category designating a reliable charging demand, and allocating any electricity available after satisfying the reliable charging demand for the second specified time period to EVs designating the flexible charging demand. The scheduling may further include limiting allocation of electricity from the grid available for charging to each category designating the reliable charging demand to a minimum of remaining electricity available from the grid and charging capacity of the EVs designating the reliable charging demand.

Embodiments may also include a computer-implemented method for controlling charging of a large number of electric vehicles (EVs) arriving and departing different charging stations at different times, the method comprising, by one or more computers: assigning one of a plurality of categories to each EV that arrives at a charging station depending on arrival time to the charging station, designated departure time from the charging station, initial state of charge (SoC) of the EV, target SoC of the EV, and a charging demand type specified by the EV; scheduling charging of each EV according to which of the plurality of categories the EV has been assigned and the charging type specified by the EV; and controlling charging of each EV based on the scheduling. The method may include scheduling based on the demand type specified by the EV corresponding to a flexible demand type, wherein EVs specifying the flexible demand type specify a minimum target SoC and a maximum target SoC, and wherein controlling charging is based on the minimum target SoC and the maximum target SoC specified by the EV. The method may include, for categories associated with the flexible demand type, scheduling based on controlling the charging to satisfy the minimum target SoC for each EV specifying the flexible demand type, and continuing to charge to the maximum target SoC responsive to profit associated with charging to the maximum target SoC exceeding a threshold. In various embodiments, the demand type includes a reliable demand type, wherein scheduling charging comprises allocating electricity available from the grid to categories associated with the reliable demand type before allocating the electricity available from the grid to categories associated with the flexible demand type. The scheduling may include assigning a penalty cost for each EV specifying the flexible demand type that is not charged to at least the minimum target SoC prior to the departure time. In various embodiments, the scheduling is based on a statistical distribution representing EV arrival times to the charging stations and designated departure times from the charging stations.

Various embodiments include a system comprising a plurality of electric vehicle (EV) charging stations each configured to charge a plugged EV during a time period specified by at least one remotely-located processor, the processor configured to schedule charging of EVs for all of the charging stations by scheduling a plurality of charging categories, each EV assigned to one of the plurality of categories by the processor based on arrival time to a charging station, expected departure time from the charging station, state of charge (SoC) of the EV upon arrival, target SoC of the EV before the expected departure time, and a charging demand type specified by the EV. Each of the plurality of charging stations may include a processor configured to control charging of an associated plugged EV according to the charging schedule. The remotely-located processor may be configured to schedule charging of EVs based on a minimum and maximum available power provided from an associated electric grid. The charging demand type may include a flexible demand having an associated minimum target SoC and maximum target SoC specified by the EV, wherein the remotely-located processor is further configured to schedule charging of EVs to provide the minimum target SoC for all EVs specifying the flexible demand, and to continue charging the EVs specifying the flexible demand above the minimum target SoC only if an associated profit exceeds a threshold.

Embodiments of the disclosure may provide one or more associated advantages. For example, vehicle manufacturers may facilitate aggregate scheduling and control of EV charging by platforms in consideration of grid demand by providing vehicle customers the ability to designate flexible charging parameters via a vehicle human-machine interface (HMI), such as a touch-screen display or wired/wireless connected smart device. Similarly, customer preferences, such as inflexible charging or flexible charging and corresponding minimum/maximum target SoC may be automatically communicated to the charging platform. The ability of the vehicle manufacturer to control an individual EV charging demand based on default or customer specified settings allows shifting of charging demand temporally and/or geographically to assist the utility companies' demand management strategy by coupling the capability to control charging of an EV with the readily available flexibility in charge scheduling while that EV is parked and plugged. The scalable and tractable framework for coordinating the charging of a large number of EVs according to embodiments of the present disclosure creates a mutually beneficial system for customers, charging platforms, and the electric utilities. Control of aggregated charging demand by the vehicle manufacturer may provide the ability for OEMs to participate in the wholesale electricity market by biding in capacity markets, demand response markets, and aggregator's markets, for example.

As those of ordinary skill in the art will appreciate, the claimed subject matter enables exchange of vehicle data in a more efficient and secure manner, enhances the data validity check before using the data for vehicle and other operations, and protects data users (whether human or controllers) from being sniffed, spoofed, or hacked.

### BRIEF DESCRIPTION OF THE DRAWINGS

FIG. 1 illustrates scheduling and control of EV charging for a large number of EVs using categorization of EVs.

FIG. 2 illustrates relative performance in terms of profits and energy, respectively, of approximate dynamic programming (ADP), simple programming (SP), and first-come first-serve (FCFS) algorithms.

FIG. 3 illustrates cumulative profits and energy consumption for reliable demand compared to cumulative profits and energy consumption for flexible demand.

FIG. 4 illustrates profits and energy consumption associated with two different penalty amounts.

FIG. 5 illustrates profits and energy consumption for flexible demand relative to varying penalties.

FIG. 6 illustrates profits and energy consumption for different grid power bounds.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Control logic, functions, code, software, algorithms, strategy etc. as described herein with reference to the figures is performed by one or more processors, controllers, computers, etc. executing instructions stored in one or more non-transitory computer readable media to control charging of individual EVs based on scheduling of the charging processes of a large number of EVs. Various steps or functions illustrated or described may be performed in the specified sequence, in parallel, or in some cases omitted. Although not always explicitly illustrated, one of ordinary skill in the art will recognize that one or more of the illustrated steps or functions may be repeatedly performed. Similarly, the specified order of processing is not necessarily required to achieve the features and advantages described herein, but is provided for ease of illustration and description.

### Notations

Let x=(xᵢ)_{i∈} [symbol] be a real multivariate with an index set [symbol] . min{x,y}:=(min{xᵢ,yᵢ}_{i∈} [symbol] is the element wise minimum of x,y. We let (xᵢ)_{i∈} [symbol] ⁺:=min{(xᵢ)_{i∈} [symbol] , 0}. Further, [symbol] ^{d×d}′ is an d×d′ dimensional all zero matrix, and [symbol] ^{d×d} is an d×d dimensional identity matrix. Let [symbol] _{b}( [symbol] ) denote the space of all continuous and bounded functions endowed with supremum norm on a set [symbol] .

Other notations used in this disclosure are provided below:
xₛ^{r}/xₛ^{f,l}—state for reliable/flexible demands)
yₛ^{r}/yₛ^{f,l}—vector of number of plugged-in EVs with reliable/flexible demands
wₛ^{r} wₛ^{f,l}—vector of number of new arrivals with reliable/flexible demands
uₛ^{r} uₛ^{f,l}—vector of the electricity allocation to each reliable/flexible category
dₛ^{r} dₛ^{f,l}—vector of grid bounds reliable/flexible demands
cₛ^{r} cₛ^{f,l}—vector of charging cost for reliable/flexible demands
zₛ^{r}—vector of remaining electricity required for each reliable demand category
zₛ^{f,l} zₛ^{f,l}—vector of maximum/minimum remaining electricity required for each flexible demand category
pₛ^{f,l}—vector of penalty if the minimum request 1 is not met
[symbol] ^{r} [symbol] ^{f,l}—menu for reliable/flexible demands
r—charging rate

According to the present disclosure, the EV charge scheduling problem is formulated as a dynamic optimization problem with a finite time horizon [symbol] ={0, . . . , T}. Consider an operator that provides a menu-based charging service—a customer plugs in the EV at time t and selects the menu (m, n) in a charging application on a connected smart phone or the panel on the charger, for example, before the charging process. The facility will supply m units of electricity from time t to time t+n−1 to the EV.

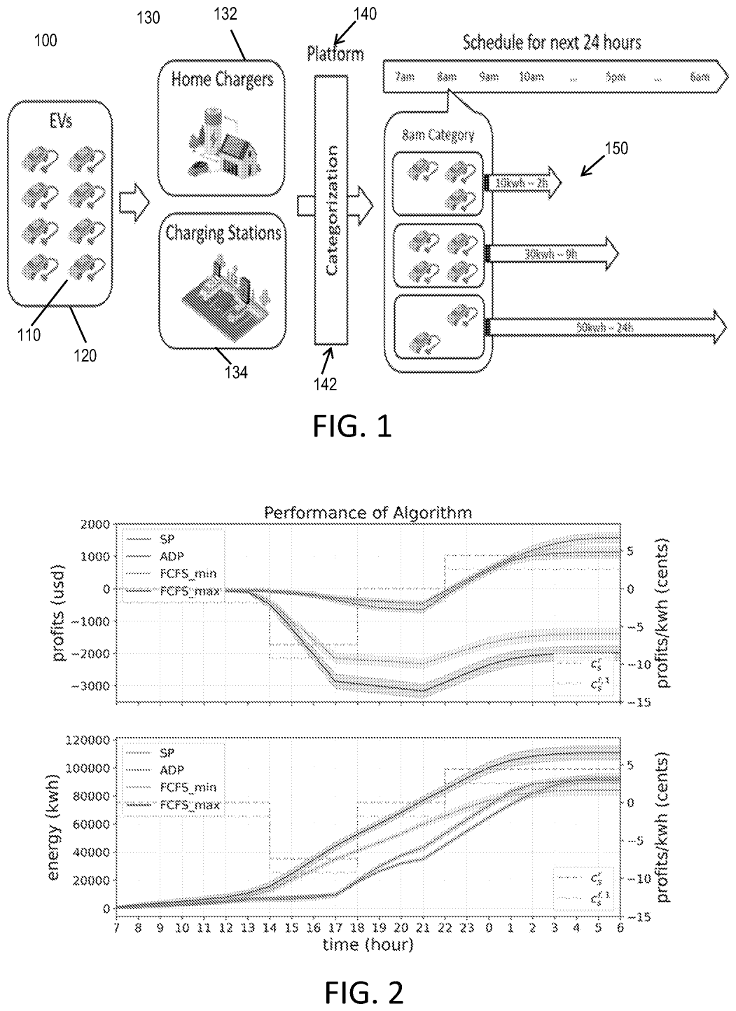

The EV charging scheduling and corresponding control problem is illustrated graphically in FIG. 1. System 100 provides EV charging scheduling and control for a group of EVs 120 including a large number of individual EVs 110 based on aggregate demand of the group and preferences or settings of the individual EVs 110 to achieve a particular goal, such as maximizing profit of the charging platform and/or managing grid demand, for example. The group of EVs 120 are typically distributed across a geographic area and arrive at different types of charging facilities 130 at different times with different planned departure times. Charging facilities 130 may include home chargers 132 and commercial charging stations 134, for example. The large group of EVs 120 are not necessarily associated or affiliated with a common manufacturer, charging facility, fleet owner, vehicle type, etc. and may be knowingly or unknowingly affiliated with a particular platform 140 that provides remote control of EV charging based on scheduling performed by platform 140 as described herein. The large group of EVs 120 may include thousands or millions of EVs across a large geographic area.

Customer vehicle charging preferences may be set by default by a vehicle manufacturer and/or may be selected by an app associated with the vehicle and accessed via mobile computing device, such as smartphone or computer, for example. One or more menu items or preferences may be selected in advance or upon arrival and plug-in at a home charger 132 or charging station 134. Those of ordinary skill in the art will appreciate that the menu parameters m, n, etc. described herein are not necessarily selectable or otherwise displayed to the customer, but may be determined by a particular charging platform 140 and used in scheduling and controlling EV charging over a selected time period as generally represented at 150 and described in detail herein. In one embodiment, menu parameters m, n, etc. are computed based on the current/target state of charge (SoC) and arrival/parking time entered by the customers, or automatically communicated by the vehicle, charging app, etc. to the charging platform, or otherwise detected by the charging platform 140. In at least one embodiment, two types of charging demands may be provided by charging platform 140 and coordinated via customer preference selection: reliable (or inflexible) and flexible demands charging. For simplicity and ease of exposition, the following description assumes that all EVs charge with a constant charging rate given by r kW. Of course, those of ordinary skill in the art will recognize that the described simplified implementation may be extended to implementations with variable charging rates or multiple charging rates.

For inflexible charging or reliable demand, the menu selections are denoted by [symbol] ^{r}⊂{1, . . . , M}×{1, . . . , N}, where an item (m, n)∈ [symbol] ^{r} means that the charging facility or platform 140 will provide m units of electricity within the next n time slots. We further let [symbol] ₙ^{r}={m: (m, n)∈ [symbol] ^{r}}. As illustrated in FIG. 1, the platform operator 140 assigns a category (t, m, n)∈T× [symbol] ^{r} to every EV depending on the preferences input by the EV owner in a smartphone app or via another vehicle or charging facility HMI as represented at 142. Let [symbol] ₛ^{r}⊂ [symbol] × [symbol] ^{r} denote the categories of EVs that are present at time s. Define [symbol] _{s,1}^{r}={(t, m, n):s=t+n−1} to be the categories of the EVs that are connected at time s but will depart at time (s+1) and [symbol] _{s,2}^{r}= [symbol] ₛ^{r}\ [symbol] _{s,1}^{r}.

Let w^{t,m,n} be the number of EVs in category (m, n) that arrive at time t, which is a non-negative bounded integer valued random variable with a known distribution. The selected known distribution may be supported by observational data collected by the charging platform or otherwise determined for a particular application or implementation. We let w^{t,m,n}=0 whenever t<0. We further assume that the sequence of random variables are mutually independent. Let wₜ^{r} be the random vector representing all new arrivals at time t:

$${w}_{t}^{r} = {[ {( {w}^{t , m , 1} )}_{m ∈ {ℬ}_{1}^{r}} , … , {( {w}^{t , m , N} )}_{m ∈ {ℬ}_{N}^{r}} ]}^{⊤} ∈ {𝒲}_{t} := {\prod }_{( m , n ) ∈ ℬ} \{ 0 , … , {\overline{w}}^{t , m , n} \} ⊂ {ℕ}^{dim ( ℬ )} .$$

We let yₛ^{r} denote the vector of the number of EVs at the charging station in each category in [symbol] ₛ^{r}:

$${y}_{s}^{r} := {( {w}^{t , m , n} )}_{( t , m , n ) ∈ {𝒥}_{s}} ∈ {𝒴}_{s} := {\prod }_{( t , m , n ) ∈ {𝒥}_{s}} \{ 0 , … , {\overline{w}}^{t , m , n} \} ,$$

where yₛ^{r} is formed in the order of leaving time, i.e.

$${y}_{s}^{r} := [ {( {w}^{s - 1 , m , 1} )}_{m ∈ {ℬ}_{1}} , … {\underbrace{, {( {w}^{s - N , m , N} )}_{m ∈ {ℬ}_{N}} ,}}_{leaving at s} … , 0 , … {\underbrace{, {( {w}^{s - 1 , m , N} )}_{m ∈ {ℬ}_{N}}}}_{leaving at s + N - 1} ] .$$

At each time s, the total electricity allocated to the EVs in the category (t, m, n)∈ [symbol] ₛ^{r} is denoted by uₛ^{t,m,n}. We let uₛ^{r} be the vector of the electricity allocation to each category (t, m, n)∈ [symbol] ₛ^{r}:

$${u}_{s}^{r} = {( {u}_{s}^{t , m , n} )}_{( t , m , n ) ∈ {𝒥}_{s}^{r}} ∈ {𝒰}_{s}^{r} := {ℝ}_{+}^{dim ( {𝒥}_{s}^{r} )} .$$

We assume that for t<0, we let uₛ^{t,m,n}=0. We also have the constraint that the total electricity allocated to all the categories having reliable demand be in the interval [dᵣ^{r}, d̅ₛ^{r}], that is, dₛ^{r}≤ [symbol] ^{T}uₛ≤d̅ₛ^{r}, where [symbol] is a column vector of all 1 of appropriate dimension. Let dₛ^{r}=[dₛ^{r}, d̅ₛ^{r}]^{T}.

Suppose that allocating one unit of electricity to (t, m, n) at time s incurs a cost cₛ^{t,m,n}. Then, the total cost to the operator at each time is cₛ^{rT} uₛ^{r}, where

$${c}_{s}^{r} = {( {c}_{s}^{t , m , n} )}_{( t , m , n ) ∈ {𝒥}_{s}^{r}} ∈ {𝒰}_{s}^{r} := {ℝ}^{dim ( {𝒥}_{s}^{r} )} .$$

Here, cₛ can represent either the cost of electricity or the cost of electricity minus the revenue per kWh from the EV owner. Thus, cₛ can take positive or negative values.

Let zₛ^{t,m,n} be the remaining electricity required by the category (t, m, n)∈ [symbol] ₛ, which is updated as

$${z}_{s + 1}^{t , m , n} = \{ \begin{matrix}{my}^{t , m , n} & s = t - 1 \\ {z}_{s}^{t , m , n} - {u}_{s}^{t , m , n} & t \leq s \leq t + n - 2 \\ 0 & s \geq t + n - 1\end{matrix} \qquad ( 1 )$$

then, let zₛ^{r} be (zₛ^{t,m,n})_{(t,m,n)∈} [symbol] _{ₛ}_{^{r}} and [symbol] ₛ⊂ [symbol] ₊^{dim(} [symbol] ^{ₛ}⁾ be the space of zₛ^{r}.

We let xₛ^{r}=[yₛ^{r}, zₛ^{r}, dₛ^{r}]∈ [symbol] ₛ^{r} be the state of the reliable demand, where [symbol] ₛ^{r}:= [symbol] ₛ× [symbol] ₛ× [symbol] ₊² is the corresponding state space, and dₛ^{r}=[dₛ^{r}, d̅ₛ^{r}] is the deterministic “actuation noise”. For simplicity, we assume that the noise has a Dirac mass at the point dₛ^{r} in a day-ahead market. This can be relaxed as described in greater detail below.

Let uₛ^{r} be the actions of the system. For each state xₛ^{r}∈ [symbol] ₛ^{r}, the feasible action uₛ^{r} should satisfy that uₛ^{r}∈Γ^{r}(xₛ^{r}), where Γₛ^{r} [symbol] [symbol] ₛ^{r} is a correspondence given by

Γ^{r}(xₛ^{r}):={uₛ^{r}∈ [symbol] ₛ^{r}:0≤uₛ^{r}≤g^{r}(xₛ^{r}),dₛ^{r}≤ [symbol] ^{T}uₛ^{r}≤d̅ₛ^{r}uₛ^{t,m,n}=zₛ^{t,m,n} for all (t,m,n)∈ [symbol] _{s,1}^{r}}, (2)

where g(xₛ^{r}):=min{ryₛ^{r},zₛ^{r}}. Here, uₛ^{r}∈Γ^{r}(xₛ^{r}) guarantees that, at each time s, the allocated electricity is upper bounded by the minimum of the remaining electricity zₛ^{r} and the charging capacity ryₛ^{r}.

As previously described, in addition to the inflexible charging selection represented by the reliable demand described above, various embodiments according to the disclosure provide aggregate scheduling of EVs that select a flexible charging service so that the platform can charge these EVs to an SoC between a selected or specified minimum target SoC and maximum target SoC. In this scenario, the menu is denoted by [symbol] ^{f}⊂{1, . . . , M}×{1, . . . , N}×{1, . . . , L} where an item (m, n, l) represents that the facility provides at least 1 and at most m units of electricity within n time slots. The notations used in the flexible demand setting are similar to the notations used previously for the reliable demand setting, but with the superscripts (t, m, n) and r replaced by (t, m, n, l) and (f, l), respectively, for the flexible demand with minimum demand l. For instance, we denote wₛ^{f,l}, yₛ^{f,l}, zₛ^{f,l}, cₛ^{f,l} and uₛ^{f,l}, respectively, as the vector of new arrivals w^{t,m,n,l}, the number of EVs at the charging station y^{t,m,n,l}, the remaining unit of electricity zₛ^{t,m,n,l}, the cost of charging cₛ^{t,m,n,l}, and the amount of charging uₛ^{t,m,n,l}.

Note that the platform only needs to meet the minimum demand l. This leads to introducing a new variable zₛ^{f,l}=(zₛ^{t,m,n,l})_{(t,m,n)∈} [symbol] _{ₛ}_{^{f,l}} to capture the remaining minimum demand, which is defined analogously with equation (1) by replacing m with l, i.e.

$${\underline{z}}_{s + 1}^{t , m , n , l} = \{ \begin{matrix}{ly}^{t , m , n , l} & s = t - 1 \\ {( {z}_{s}^{t , m , n , l} - {u}_{s}^{t , m , n , l} )}^{+} & t \leq s \leq t + n - 2 \\ 0 & s \geq t + n - 1\end{matrix} .$$

We also denote zₛ^{f,l} as the vector of

$${( {\underline{z}}_{s + 1}^{t , m , n , l} )}_{( t , m , n , l ) ∈ {𝒥}_{s}^{f , l}} .$$

The reliable demand setting uses an equality constraint in equation (2) to impose that the demand m is met within the charging window. Instead, under the flexible demand setting, the platform will compensate the customers whose minimum demand is not met. Let

$${p}_{s}^{f , l} = {( {p}_{s}^{t , m , n , l} )}_{( t , m , n . l ) ∈ {𝒥}_{s , 1}^{f , l}}$$

be the penalty vector, which is the monetary penalty per kWh that the platform pays to the customer, if the minimum demand l is not met at the end of the charging window. The total penalty paid by the platform at each time s is given by

$${p}_{s}^{f , {l}^{⊤}} [ {( {\underline{z}}_{s}^{f , l} - {u}_{s}^{f , l} )}_{( t , m , n , l ) ∈ {𝒥}_{s , 1}^{f , l}}^{+} ] .$$

In this case, we let xₛ^{f,l}=[yₛ^{f,l},zₛ^{f,l}, zₛ^{f,l},dₛ^{f,l}]∈ [symbol] ₛ^{f} be the state of flexible demand and [symbol] ₛ^{f}:= [symbol] ₛ× [symbol] ₛ× [symbol] ₛ× [symbol] ₊². Further, the feasible action set for the flexible demand is the correspondence Γ^{f,l}: [symbol] ₛ^{f}→ [symbol] , which is

$${Γ}^{f , l} ( {x}_{s}^{f , l} ) := \{ {u}_{s}^{f , l} ∈ 𝒰 : 0 \leq {u}_{s}^{f , l} \leq g ( {x}_{s}^{f , l} ) , {d}_{s}^{f , l} \leq {⊤}^{} {u}_{s}^{f , l} \leq {\overline{d}}_{s}^{f , l} \} , \qquad ( 3 )$$

where dₛ^{f,l}=(dₛ^{f,l}, d̅ₛ^{f,l}) is defined similarly with dₛ^{r} below. In this case, we let dₛ=(dₛ,d̅ₛ) be the total energy bound for the platform (both reliable and flexible demand) at each time s, then dₛ^{r} and dₛ^{f,l} satisfy that

$${\overline{d}}_{s} = {\overline{d}}_{s}^{r} + {\sum }_{l = 1}^{L} {\overline{d}}_{s}^{f , l} , {\underline{d}}_{s} = {\underline{d}}_{s}^{r} + {\sum }_{l = 1}^{L} {\underline{d}}_{s}^{f , l} , l = 1 , … , L . \qquad ( 4 )$$

The feasible set of flexible demand represented by equation (3) removes the equality constraints in equation (2), which allows charging an EV in (t, m, n, l) from 0 to m units of electricity. Note that the penalty pₛ^{f,l} can be changed to ensure the minimum demand l is satisfied.

We next determine the state of the EV charging system, the transition dynamics, and pose the stochastic dynamic program.

The system has linear dynamics for both reliable and flexible demand with minimum demand l, and the state transition functions ƒ^{r}, ƒ^{f,1}, . . . , ƒ^{f,L} given by:

$${x}_{s + 1}^{r} = {f}^{r} ( {x}_{s}^{r} , {u}_{s}^{r} , {w}_{s}^{r} , {d}_{s + 1}^{r} ) := [ \begin{matrix}{A}_{y}^{r} {y}_{s}^{r} + {C}_{y}^{r} {w}_{s}^{r} \\ {A}_{z} ( {z}_{s}^{r} - {u}_{s}^{r} ) + {C}_{z}^{r} {w}_{s}^{r} \\ {d}_{s + 1}^{r}\end{matrix} ] , \qquad ( 5 )$$

$$\begin{matrix}{x}_{s}^{f , l} = {f}^{r} ( {x}_{s}^{f , l} , {u}_{s}^{f , l} , {w}_{s}^{f , l} , {d}_{s + 1}^{f , l} ) \\ := [ \begin{matrix}{A}_{y}^{f , l} {y}_{s}^{f , l} + {C}_{y}^{f , l} {w}_{s}^{f , l} \\ {A}_{z}^{f , l} {z}_{s}^{f , l} - {u}_{s}^{f , l} + {C}_{z}^{f , l} {w}_{s}^{f , l} \\ {A}_{z} ( {\underline{z}}_{s}^{f , l} - {u}_{s}^{f , l} ) + {C}_{\underline{z}}^{f , l} {w}_{s}^{f , l} \\ {d}_{s + 1}^{f , l}\end{matrix} ] , l = 1 , … , L\end{matrix}$$

where the time invariant matrices A_{y}^{r}, A_{z}^{r}, C_{y}^{r}, C_{z}^{r} are given as follows:

$${A}_{y}^{r} = {A}_{z}^{r} = [ \begin{matrix}{𝕆}^{\vert {𝒥}_{s}^{2} \vert \times \vert {𝒥}_{s}^{1} \vert} & {𝕀}^{\vert {𝒥}_{s}^{2} \vert \times \vert {𝒥}_{s}^{2} \vert} \\ {𝕆}^{\vert {𝒥}_{s}^{1} \vert \times \vert {𝒥}_{s}^{1} \vert} & {𝕆}^{\vert {𝒥}_{s}^{1} \vert \times \vert {𝒥}_{s}^{2} \vert}\end{matrix} ] ,$$

$${C}_{y}^{r} = [ \begin{matrix}{C}_{y}^{1} & 0 & … & 0 \\ 0 & {C}_{y}^{2} & … & 0 \\ ⋮ & ⋮ & & ⋮ \\ 0 & 0 & … & {C}_{y}^{N}\end{matrix} ] , {C}_{z}^{r} = [ \begin{matrix}{C}_{z}^{1} & 0 & … & 0 \\ 0 & {C}_{z}^{2} & … & 0 \\ ⋮ & ⋮ & & ⋮ \\ 0 & 0 & … & {C}_{z}^{N}\end{matrix} ] ,$$

$${C}_{y}^{k} = [ \begin{matrix}\begin{matrix}0 \\ ⋮\end{matrix} \\ {𝕀}^{\vert {ℬ}_{k} \vert \times \vert {ℬ}_{k} \vert} \\ ⋮ \\ 0\end{matrix} ] ,$$

$${C}_{z}^{k} = [ \begin{matrix}\begin{matrix}0 \\ ⋮\end{matrix} \\ diag ( {\{ m \}}_{m ∈ {ℬ}_{k}} ) \\ ⋮ \\ 0\end{matrix} ] , {ℬ}_{k} = \{ ( m , n ) ∈ ℬ : n = k \} .$$

and A_{y}^{f,l}, A_{z}^{f,l}, C_{y}^{f,l},C_{z}^{f,l} are given by

$${A}_{y}^{f , l} = {A}_{z}^{f , l} = [ \begin{matrix}{𝕆}^{dim ( {𝒥}_{s , 2}^{f , l} ) \times dim ( {𝒥}_{s , 1}^{f , l} )} & {𝕀}^{dim ( {𝒥}_{s , 2}^{f , l} ) \times dim ( {𝒥}_{s , 2}^{f , l} )} \\ {𝕆}^{dim ( {𝒥}_{s , 1}^{f , l} ) \times dim ( {𝒥}_{s , 1}^{f , l} )} & {𝕆}^{dim ( {𝒥}_{s , 1}^{f , l} ) \times dim ( {𝒥}_{s , 2}^{f , l} )}\end{matrix} ] ,$$

$${C}_{y}^{f , l} = [ \begin{matrix}{C}^{1} & … & 0 \\ ⋮ & ⋱ & ⋮ \\ 0 & … & {C}^{N}\end{matrix} ] , {C}^{k} = [ \begin{matrix}\begin{matrix}0 \\ ⋮\end{matrix} \\ {𝕀}^{dim ( {ℬ}_{k} ) \times dim ( {ℬ}_{k} )} \\ ⋮ \\ 0\end{matrix} ] ,$$

$${C}_{z}^{f , l} = [ \begin{matrix}{C}_{z}^{1 , l} & … & 0 \\ ⋮ & ⋱ & ⋮ \\ 0 & … & {C}_{z}^{N , l}\end{matrix} ] , {C}_{\underline{z}}^{f , l} = [ \begin{matrix}{C}_{\underline{z}}^{1 , l} & … & 0 \\ ⋮ & ⋱ & ⋮ \\ 0 & … & {C}_{\underline{z}}^{N , l}\end{matrix} ] ,$$

$${C}_{z}^{k , l} = [ \begin{matrix}\begin{matrix}0 \\ ⋮\end{matrix} \\ diag ( {\{ m \}}_{m ∈ {ℬ}_{k}^{f , l}} ) \\ ⋮ \\ 0\end{matrix} ] , {C}_{\underline{z}}^{k , l} = [ \begin{matrix}\begin{matrix}0 \\ ⋮\end{matrix} \\ diag ( {\{ l \}}_{l ∈ {ℬ}_{k}^{f , l}} ) \\ ⋮ \\ 0\end{matrix} ] , where$$

$${ℬ}_{k}^{f , l} = \{ ( m , n , {l}^{′} ) ∈ {ℬ}^{f} : n = k , {l}^{′} = l \} .$$

At time s, a feasible policy of both reliable and flexible situations forms a measurable map πₛ: [symbol] ₛ^{r}× [symbol] ₛ^{f}→ [symbol] ₛ^{r}× [symbol] ₛ^{f} where [symbol] ₛ^{f}:=Πₗ₌₁^{L} [symbol] ₛ^{f,l} and [symbol] ₛ^{f}:=Πₗ₌₁^{L} [symbol] ₛ^{f,l}. Note that based on equation (4) the feasible policy πₛ satisfies that

$${π}_{s} ( {x}_{s}^{r} , {x}_{s}^{f} ) ∈ Γ ( {x}_{s}^{r} , {x}_{s}^{f} ) := \{ ( {u}_{s}^{r} , {u}_{s}^{f} ) ∈ {𝒰}_{s}^{r} \times {𝒰}_{s}^{f} : {u}_{s}^{r} ∈ {Γ}^{r} ( {x}_{s}^{r} ) , {u}_{s}^{f , l} ∈ {Γ}^{f , l} ( {x}_{s}^{f , l} ) , \qquad ( 6 )$$

$$for all i = 1 , … , L , {\underline{d}}_{s} \leq {⊤}^{} {u}_{s}^{r} + {\sum }_{i = 1}^{L} {⊤}^{} {u}_{s}^{f , l} \leq {\overline{d}}_{s} \} .$$

Let Πₛ denote the set of all feasible policies, π=(π₀, . . . , π_{T}) denote a feasible strategy of the platform, and Π:=ΠₛΠₛ denote the feasible strategy space.

We now introduce the finite time horizon stochastic dynamic program (DP). The expected total cost of the reliable and flexible demand based on the initial state x=[x^{r}, x^{f}] and using the strategy π is given by

$$J ( π ; x ) = 𝔼 [ {\sum }_{s = 1}^{T} ( \underbrace{{c}_{s}^{{r}^{T}} {π}_{s}^{r} ( {x}_{s}^{r} )}_{reliable demand cost} + {\sum }_{l = 1}^{L} ( \underbrace{{c}_{s}^{f , {l}^{T}} {π}_{s}^{f , l} ( {x}_{s}^{f , l} )}_{flexible demand cost} + \underbrace{{p}_{s}^{f , {l}^{T}} {( l - {\sum }_{τ = t}^{s} {π}_{s}^{f , l} ( {x}_{s}^{f , l} ) )}_{( t , m , n , l ) ∈ {𝒥}_{s , 1}^{f , l}}^{+} )}_{flexible demand penalty} ) \vert [ {x}_{0}^{r} , {x}_{0}^{f , l} ] = x ] . \qquad ( 7 )$$

That is, for the flexible demand in category (t, m, n, l), the platform will try to satisfy the minimum demand l, and will keep charging up to their battery capacity m whenever it is profitable. However, in case d̅ₛ is small, then the platform pays a penalty to the EVs in category [symbol] _{s,1}^{f,l} whose minimum demand was not met and who need to leave at time s+1.

The goal is to minimize the expected total cost from s=1 to s=T given the initial state x, which can be solved using the usual dynamic programming method under fairly mild conditions. The optimal value functions v s can be obtained by applying Bellman operator Hₛ for each time s=T, . . . , 1, where the Bellman operator is defined as

$${v}_{s}^{*} ( {x}_{s} ) = {H}_{s + 1} ( {v}_{s + 1}^{*} ) ( {x}_{s} ) := {inf}_{( {u}_{s}^{r} , {u}_{d}^{f} ) ∈ Γ ( {x}_{s}^{r} , {x}_{s}^{f , l} )} {c}_{s}^{{r}^{T}} {u}_{s}^{r} + {\sum }_{l = 1}^{L} ( {c}_{s}^{f , {l}^{T}} {u}_{s}^{f , l} + {p}_{s}^{f , {l}^{T}} [ {( {\underline{z}}_{s}^{f , l} - {u}_{s}^{f , l} )}_{( t , m , n ) ∈ {𝒥}_{s , 1}^{f , l}}^{+} ] ) + 𝔼 [ {v}_{s + 1}^{*} ( f ( {x}_{s} , {u}_{s} , {W}_{s} , {d}_{s + 1} ) ) ] , \qquad ( 8 )$$

where v_{T+1}*(x_{T+1})≡0, and f(xₛ, uₛ, Wₛ, dₛ₊₁) is abuse of notation representing the state transition functions (5) of xₛ=[xₛ^{r},xₛ^{f}], uₛ=[uₛ^{r},uₛ^{f}], Wₛ=[Wₛ^{r},Wₛ^{f}], and dₛ₊₁.

In this case, we can obtain the optimal scheduling policies π*=[πₛ* [symbol] SET by applying the value iteration vₛ*=Hₛ₊₁(vₛ₊₁*) in (8) from time s=T to time s=1 recursively. Here, πₛ*(xₛ) is the minimizer in (8).

As those of ordinary skill in the art may appreciate, with a sufficiently large menu size [symbol] ^{r} and [symbol] ^{f}, the dimensionality of the state and action spaces also becomes large. In this case, computing vₛ for each s∈ [symbol] is challenging due to the curse of dimensionality. As such, embodiments according to the present disclosure leverage Approximate Dynamic Programming (ADP) to compute the approximately optimal value functions.

The two main challenges to overcome for obtaining the approximately optimal value functions are computing of expectation in the Bellman operator and storing approximately optimal value functions. The first challenge is mitigated by using the empirical Bellman operator, which uses independent and identically distributed (i.i.d). samples of noise to approximate the computation of the expected future value. The second challenge is mitigated by using a projection operator, which takes the values from the computation of the empirical Bellman operator as inputs, and a function in the chosen function approximating class as outputs.

We use empirical Bellman operator Ĥₛ₊₁^{k}: [symbol] _{b}( [symbol] ₛ)→ [symbol] _{b}( [symbol] ₛ) to approximate the actual Bellman operator Hₛ₊₁. Let {W_{s,i}}ᵢ₌₁^{k} be a sequence of independent identically distributed (i.i,d.) samples of wₛ, then the empirical Bellman operator Ĥₛ₊₁^{k} is given by

$${\hat{v}}_{s}^{k} ( {x}_{s} ) = {\hat{H}}_{s + 1}^{k} ( {\hat{v}}_{s + 1}^{`k} ) ( {x}_{s} ) := {inf}_{{u}_{s} ∈ Γ ( {x}_{s} )} {c}_{s}^{T} {u}_{s} + \frac{1}{k} {\sum }_{i = 1}^{k} {\hat{v}}_{s + 1}^{k} ( f ( {x}_{s} , {u}_{s} , {W}_{s , i} ) ) .$$

While applying the value iteration, it is necessary to store a function approximator of \hat{v}ₛ^{k} in computers readable memory/storage. The function approximator can be obtained by projecting the value function \hat{v}ₛ^{k} onto a feasible function approximating class, such as neural networks or reproducing kernel Hilbert space (RKHS), which is dense in [symbol] _{b}( [symbol] ).

$$Loss ( {\hat{v}}_{s}^{k} , h \vert {\{ {x}_{s , j} \}}_{j = 1}^{l} ) = \frac{1}{l} {\sum }_{j = 1}^{l} {( {\hat{v}}_{s}^{k} ( {x}_{s , j} ) - h ( {x}_{s , j} ) )}^{2} .$$

We denote Πₛ^{l,d}: [symbol] _{b}( [symbol] ₛ)→ [symbol] _{d}( [symbol] ₛ) as the function approximating projection that maps the output of Ĥₛ₊₁^{k}(\hat{v}ₛ₊₁^{k}) to a function in [symbol] _{d}. This is defined as

$${\prod }_{s}^{l , d} ( {\hat{v}}_{s}^{k} ) = arg {inf}_{h ∈ {𝒢}_{d}} Loss ( {\hat{v}}_{s}^{k} , h \vert {\{ {x}_{s , j} \}}_{j = 1}^{l} ) .$$

We here construct a composited operator that combines the empirical Bellman operator and function approximating operator. We let

Ψₛ^{k,l,d}=Πₛ^{l,d}∘Ĥₛ₊₁^{k}: [symbol] _{d}( [symbol] ₛ₊₁)→ [symbol] _{d}( [symbol] ₛ)

be the random fitted empirical Bellman operator used in place of the actual Bellman operator Hₛ₊₁ to arrive at an approximate function \hat{v}ₛ. Here, k is the number of samples generated, d is a parameter describing the size of the function approximating class, and l is the number of samples used in computing the empirical loss function for the projection operation.

We define the fitted value iteration at time s∈ [symbol] as

\hat{v}ₛ^{k,l,d}(xₛ)=Ψₛ^{k,l,d}(\hat{v}ₛ₊₁^{k,l,d})(xₛ).

We now proceed to proving that this fitted value iteration algorithm converges as we increase k, l, d→∞. In what follows, we aim at increasing the k, l, d simultaneously. Let j∈ [symbol] and k(j), l(j), d(j) be such that as j→∞, we have k(j), l(j), d(j)→∞. By a slight abuse of notation, we denote Ĥₛ₊₁^{j}:=Ĥₛ₊₁^{k(j)}, Πₛ^{j}:=Πₛ^{l(j),d(j)}, and the fitted value iteration algorithm by

\hat{v}ₛ^{j}(xₛ):=Ψₛ^{j}(\hat{v}ₛ₊₁^{j})(xₛ):=Ψₛ^{k(j),l(j),d(j))}(\hat{v}ₛ₊₁^{k(j),l(j),d(j)})(xₛ).

To establish the convergence of the proposed algorithms, we also need the following reasonable assumptions on the projection operators.

Assumption 1. The projection operator Πₛ^{l,d}: [symbol] _{b}( [symbol] ₛ)→ [symbol] _{d}( [symbol] ₛ) satisfies the followings two conditions:
1. Πₛ^{l,d} is approximately non-expansive, that is, for all v₁, v₂∈ [symbol] _{b}( [symbol] ₛ), we have ∥Πₛ^{l,d} (v₁)−Πₛ^{l,d}(v₂)∥_{∞}≤∥v₁−v₂∥_{∞}\hat{ζ}ₛ^{l,d}, where \hat{ζ}ₛ^{l,d}≤\hat{ζ}ₛ≤∞ almost surely and \hat{ζ}ₛ^{l,d}→>0 as l, d→∞ in probability.
2. For any ϵ>0 and δ>0, there exists Mₗ, M_{d} that may depend on vₛ* such that [symbol] (∥Πₛ^{l,d}(vₛ*)−vₛ*∥_{∞}>ϵ)<δ for all l≥Mₗ, d≥M_{d}.

Under the assumptions listed above, we have the following theorem where the convergence of the fitted value iteration algorithm is established.

Theorem 1: If Assumption 1. holds, then \hat{v}ₛ^{j} satisfies for any κ>0,

$${limsup}_{j \to ∞} ℙ ( {‖ {\hat{v}}_{s}^{j} - {v}_{s}^{*} ‖}_{∞} > κ ) = 0.$$

The proof of the Theorem is established below. Thus, as we increase the number of samples for empirical Bellman operator, expand the function approximating class to include more parameters, and take more samples of the state to project the value function to the function approximating class, we are guaranteed to converge to the optimal value functions under the sup norm.

Proof. We first establish two auxiliary results to establish the theorem. The first statement establishes that the empirical Bellman operator is non-expansive. The second statement shows that the empirical Bellman operator Ĥₛ₊₁^{j} when applied on vₛ₊₁* converges to vₛ* in probability as j→∞.
Lemma 1. For any v,v′∈ [symbol] _{b}( [symbol] ₛ₊₁) and any realization of the random operator Ĥₛ₊₁^{j}, we have ∥Ĥₛ₊₁^{j}(v)−Ĥₛ₊₁^{j}(v′)∥_{∞}≤∥v−v′∥_{∞} almost surely. The proof is straightforward and therefore omitted.
Lemma 2. For any ϵ>0, we have the following holds:

$${lim}_{k \to ∞} ℙ ( {‖ {\hat{H}}_{s + 1}^{k} ( {v}_{s + 1}^{*} ) - {H}_{s + 1} ( {v}_{s + 1}^{*} ) ‖}_{∞} \geq ϵ ) = 0 ,$$

The proof may be found in the published literature.

We now proceed to proving Theorem 1 using the principle of mathematical induction. We have

∥\hat{v}ₛ^{j}−vₛ*∥_{∞}≤∥Ψₛ^{j}(\hat{v}ₛ₊₁^{j})−Ψₛ^{j}(vₛ₊₁*)∥_{∞}+∥Ψₛ^{j}(vₛ₊₁*)−Hₛ₊₁(vₛ₊₁*)∥_{∞}.

Let us consider the first summand on the right side of the equation above. We have

∥Ψₛ^{j}(\hat{v}ₛ₊₁^{j})−Ψₛ^{j}(vₛ₊₁*)∥_{∞}≤∥Ĥₛ₊₁^{j}(\hat{v}ₛ₊₁^{j})−Ĥₛ₊₁^{j}(vₛ₊₁*)∥_{∞}+ζₛ^{j}≤∥\hat{v}ₛ₊₁^{j}−vₛ₊₁*∥_{∞}+ζₛ^{j},

where we used Lemma 1 and Assumption 1(1). Next, we consider the second summand on the right side of the equation:

∥Ψₛ^{j}(vₛ₊₁*)−Hₛ₊₁(vₛ₊₁*)∥_{∞}=∥Πₛ^{j}(Ĥₛ₊₁^{j}(vₛ₊₁*))−vₛ*∥_{∞}≤∥Πₛ^{j}(Ĥₛ₊₁^{j}(vₛ₊₁*))−Πₛ^{j}(vₛ*)∥_{∞}+∥Πₛ^{j}(vₛ*)−vₛ*∥_{∞}≤∥Ĥₛ₊₁^{j}(vₛ₊₁*))−vₛ*∥_{∞}+ζₛ^{j}+∥Πₛ^{j}(vₛ*)−vₛ*∥_{∞},

where the first inequality is due to the triangle inequality and the second inequality is due to Assumption 1(1). Thus, we conclude that

∥\hat{v}ₛ^{j}−vₛ*∥_{∞}≤∥\hat{v}ₛ₊₁^{j}−vₛ₊₁*∥_{∞}+∥Ĥₛ₊₁^{j}(vₛ₊₁*))−vₛ*∥_{∞}+∥Πₛ^{j}(vₛ*)−vₛ*∥_{∞}+2ζₛ^{j}.

For time s=T, we have v_{T+1}*=\hat{v}_{T+1}^{j}=0. As j→∞, all three terms on the right goes to 0 in probability due to Lemma 2, Assumption 1(1), and Assumption 1(2). Thus, ∥\hat{v}_{T}^{j}−v_{T}*∥_{∞}→0 in probability as j→∞ and the statement holds for time T. For any time s, we can use the same argument to conclude that as j→∞, ∥\hat{v}ₛ^{j}−vₛ*∥_{∞}→∞ in probability. The proof of the theorem is complete.

Next, we examine three crucial properties of the value function: monotonicity and Lipschitz continuity with respect to the state xₛ, and continuity with respect to the system parameters.

### Monotonicity of Value Functions

Note that any realization of the state xₛ is a non-negative vector in [symbol] ^{|} [symbol] ^{ₛ}^{|}× [symbol] ₊^{|} [symbol] ^{ₛ}^{|}× [symbol] ². Endow the state space [symbol] ₛ with the following partial order: Let xₛ, xₛ′∈ [symbol] . Then, xₛ≤xₛ′ if and only if yₛ≤yₛ′, zₛ^{t,m,n}=z′ₛ^{t,m,n}=z′ₛ^{t,m,n} for every (t, m, n)∈ [symbol] ₛ¹, zₛ^{t,m,n}≤z′ₛ^{t,m,n} for every (t, m, n)∈ [symbol] ₛ², and dₛ≤dₛ′. A function v: [symbol] ₛ→ [symbol] is said to be a monotonically increasing function if and only if for any x, x′∈ [symbol] ₛ such that x≤x′, we have v(x)≤v(x′). A function v: [symbol] → [symbol] is said to be a monotonically decreasing function if and only if −v is monotonically increasing. In this section, we show that the dynamic optimization problem formulated above yields monotonically decreasing value functions at all times.

Theorem 2: For each s∈ [symbol] , the optimal value function vₛ* is a monotonically decreasing function of xₛ.

Proof. To show this, we first note that for any x≤x′, we have:
1. Γ(x)⊆Γ(x′).
2. f(x,u,w,dₛ₊₁)≤f(x′,u,w,dₛ₊₁) for all u∈Γ(x) and w∈ [symbol] ₛ.

We now prove the statement using induction. The terminal cost is 0, so it is trivially monotone decreasing. Assume that vₛ₊₁* is monotonically decreasing. We claim that vₛ*=Hₛ₊₁(vₛ₊₁*) is also monotone decreasing function. Pick x, x′∈ [symbol] ₛ such that x≤x′, u∈Γ(x) and w∈ [symbol] ₛ. Since f(x, u, w)≤f(x′,u, w) and vₛ₊₁* is monotonically decreasing, we conclude that

vₛ₊₁*(f(x′,u,w,dₛ₊₁))≤vₛ₊₁*(f(x,u,w,dₛ₊₁)).

Consequently, [symbol] [vₛ₊₁*(f(∩,u,W,dₛ₊₁)] is also monotonically decreasing function. This yields

$${inf}_{u ∈ Γ ( x )} {c}_{s}^{T} u + 𝔼 [ {v}_{s + 1}^{*} ( f ( x , u , W , {d}_{s + 1} ) ) ] \geq {inf}_{u ∈ Γ ( x ′ )} {c}_{s}^{T} u + 𝔼 [ {v}_{s + 1}^{*} ( f , x , u , W , {d}_{s + 1} ) ) ] \geq {inf}_{u ∈ Γ ( x ′ )} {c}_{s}^{T} u + 𝔼 [ {v}_{s + 1}^{*} ( f , {x}^{′} , u , W , {d}_{s + 1} ) ) ] ,$$

where the first inequality is due to Γ(x)⊆Γ(x′), and the second inequality results from the conclusion above. In other words, vₛ* is monotonically decreasing. An application of the principle of mathematical induction implies that vₛ* is monotone decreasing for all s.

### Lipschitz Continuity of Value Functions

We now endow the state and the action space with metrics and establish the Lipschitz continuity of the value functions. Let [symbol] := [symbol] ₀= [symbol] ₂= . . . = [symbol] _{T} and a same convention is applied for [symbol] . Define the metric on [symbol] and [symbol] as

ρₓ(x,x′)=∥x−x′∥_{∞},ρ [symbol] (u,u′)=∥u−u′∥_{∞},

for any x, x′∈ [symbol] ,u,u′∈ [symbol] . Let 2 [symbol] denote the set of all compact subsets of [symbol] . We endow this space with the Hausdorff metric, given by

$${ρ}_{J} ( ⋃ , {⋃}^{′} ) = max \{ {sup}_{u ∈ ⋃} {inf}_{u ′ ∈ ⋃ ′} {ρ}_{U} ( u , {u}^{′} ) , {sup}_{u ′ ∈ ⋃ ′} {inf}_{u ∈ ⋃} {ρ}_{U} ( u , {u}^{′} ) \} ,$$

for all U,U′⊂ [symbol] .

Theorem 3: The value function vₛ* is a Lipschitz continuous function.

Proof. We first claim the following statements:
1. The correspondence Γ: [symbol] ₛ→ [symbol] , is Lipschitz continuous with coefficient L_{Γ}=max{r, 1}: For any x, x′∈ [symbol] ₛ, we have ρ_{H}(Γ(x), Γ(x′))≤L_{Γ}ρ_{X}(x, x′).
2. For every w∈ [symbol] ₛ, the state transition function ƒ(∩,∩, w) is Lipschitz continuous in (x, u)∈ [symbol] ₛ with Lipschitz coefficient L_{f}(w)≡1 and L_{P}:=∫L_{f}(w) [symbol] (dw)=1≤∞.
3. The cost function cₛ: [symbol] ₛ→ [symbol] is Lipschitz continuous with Lipschitz coefficient L_{c}_{ₛ}:=∥cₛ∥₁.

We can write Γ(x) as Γ(x)={u∈ [symbol] ₛ: u≥0, Q₁u≤Q₂x, Q₃u=Q₄x} for appropriate matrices Q₁, Q₂, Q₃, Q₄ that have bounded entries. Thus, the constraint set is actually a polyhedral set. We conclude that Γ is a Lipschitz continuous correspondence with Lipschitz coefficient L_{Γ}. The exact value of Lipschitz coefficient is difficult to derive with more detailed discussions on upper bounds on L_{Γ} available in the published literature.

We now prove the second claim. Using triangle inequality, we have

∥f(x,u,w)−f(x′,u′,w)∥_{∞}≤∥A∥_{∞}∥x−x′∥_{∞}+∥B∥_{∞}μu−u′∥_{∞}≤(∥x−x′∥_{∞}+∥u−u′∥_{∞})

which shows that f is Lipschitz continuous over [symbol] ₛ with Lipschitz coefficient 1. The Lipschitz coefficient of the cost function is derived from the Cauchy Schwarz inequality.

It can be shown that the Lipschitz continuity of the value function then follows, outlined as follows. Suppose that vₛ₊₁* is Lipschitz continuous with Lipschitz coefficient. Then, it can be concluded that

|vₛ*(xₛ)−vₛ*(x′ₛ)|≤|cₛ^{T}uₛ*−cₛ^{T}u′ₛ*|+| [symbol] [vₛ₊₁*(f(xₛ,uₛ*,wₛ,dₛ₊₁))]− [symbol] [vₛ₊₁*(f(xₛ′,u′ₛ*,wₛ,dₛ₊₁))]|≤L_{c}_{ₛ}L_{Γ}∥xₛ−xₛ′∥_{∞}+Lᵥ_{ₛ₊₁}_{*}(1+L_{Γ})∥xₛ−xₛ′∥_{∞}≤(L_{c}_{ₛ}L_{Γ}+Lᵥ_{ₛ₊₁}_{*}L_{P}(1+L_{Γ}))∥xₛ−xₛ′∥_{∞},

which implies vₛ* is Lipschitz continuous with Lipschitz constant Lᵥ_{ₛ}_{*}=L_{c}_{ₛ}L_{Γ}+Lᵥ_{ₛ₊₁}_{*}(1+L_{Γ}) (since L_{P}=1). The induction step is complete.
Robustness of Value Functions with Respect to Parameters

The problem identified here has multiple parameters that can change over time. For instance, the cost of acquiring electricity in the wholesale markets or the distribution of the EV arrival process may change slightly over time. This can be studied under the umbrella of parameterized dynamic programs, where the parameters influence the cost/profit functions or the EV arrival process. We investigate in this section the continuity of the value function as a function of the parameters. We identify some sufficient conditions under which a slight change in the parameters would lead to a slight change in the value function. This allows us to conclude the robustness of the scheduling algorithm with respect to small parametric uncertainty.

Let Θ⊂ [symbol] ^{q} be the parameter space, which is assumed to be a compact subset of a Euclidean space. We consider a parameterized optimization problem, parameterized by θ∈Θ, in which:
1. \tilde{c}ₛ(θ) is the negative profit function; and
2. The probability distribution of the EV arrival process \tilde{w}ₛ is given by vₛ(⋅, θ).
   The parameterized dynamic program is then rewritten as:

$${\tilde{v}}_{s}^{*} ( {x}_{s} , θ ) = {inf}_{{u}_{s} ∈ Γ ( {x}_{s} )} {{\tilde{c}}_{s} ( θ )}^{T} {u}_{s} + {𝔼}_{{v}_{s} ( θ )} [ {\tilde{v}}_{s + 1}^{*} ( f ( {x}_{s} , {u}_{s} , {\tilde{w}}_{s} , {d}_{s + 1} ) , θ ) ] .$$

Here, \tilde{v}ₛ*: [symbol] ₛ×Θ→ [symbol] is the optimal parameterized value function. We also let \tilde{π}ₛ*(xₛ, θ) be the corresponding parameterized scheduling policy. We identify some sufficient conditions and establish the continuity of \tilde{v}ₛ* and lower semicontinuity of \tilde{π}ₛ* below.

Assumption 2. The following holds:
1. \tilde{c}ₛ is continuous on Θ; and
2. There exists a base probability measure λₛ and a continuous and bounded function βₛ: [symbol] ₛ×Θ→[0, ∞) such that vₛ(dw,Θ)=βₛ(w,θ)λₛ(dw).

Theorem 4. Suppose that Assumption 2 holds. Then, \tilde{v}* is jointly continuous on [symbol] ₛ×Θ and \tilde{π}ₛ* is lower semi-continuous on Xₛ×Θ.

Proof. Assumption 2(1) implies the cost function (uₛ, θ) [symbol] ₛ(θ)^{T}uₛ is jointly continuous on Θ× [symbol] ₛ. Since the state transition function ƒ is a linear map, then linearity of ƒ and Assumption 2(2) implies that for any h∈ [symbol] _{b}( [symbol] ₛ₊₁) and any convergent sequence {(xₙ, uₙ, θₙ)}ₙ⊂ [symbol] ₛ× [symbol] ₛ×Θ satisfying (xₙ, uₙ, θₙ)→(x, u, θ), we have h(f(xₙ, uₙ, w, d))βₛ(w, θₙ)→h(f(x, u, w, d))βₛ(w, θ). Further, since h, βₛ are continuous and bounded functions, we conclude that

$${lim}_{n \to ∞} \int h ( f ( {x}_{n} , {u}_{n} , w , {d}^{′} ) ) {v}_{s} ( dw , {θ}_{n} ) = {lim}_{n \to ∞} \int h ( f ( {x}_{n} , {u}_{n} , w , {d}^{′} ) ) {β}_{s} ( w , {θ}_{n} ) {λ}_{s} ( dw ) {=}^{( a )} \int h ( f ( x , u , w , {d}^{′} ) ) {β}_{s} ( s , θ ) {λ}_{s} ( dw ) = \int h ( f ( x , u , w , {d}^{′} ) ) {v}_{s} ( dw , θ ) ,$$

where the equality in (a) results from the dominated convergence theorem as [symbol] ₛ, [symbol] ₛ, [symbol] , Θ are compact.

Note that we have also shown in the proof of Theorem 3 that Γ(xₛ) is a continuous and compact-valued correspondence. Thus, it can be implied that \tilde{v}ₛ* is continuous on [symbol] ₛ×Θ and \tilde{π}ₛ* is lower semi-continuous on Xₛ×Θ, which completes the proof.

In contrast to the above, which is based on a single demand type (reliable demand), we now take into account the flexible demand that allows flexible charging between a minimum target SoC and maximum target SoC within the available charging time. In this scenario, the dimensionality of state space of the flexible demand, [symbol] ₛ^{f}, linearly increases with L, which significantly increases the computational complexity. To alleviate the problem, we decouple the original problem into L+1 serial stages to reduce the dimensionality of the state space. The detailed algorithm and the corresponding optimality results are described below.

The scheduling problem (7) can be solved by the Empirical Fitted Value Iteration algorithm, which aims at efficiently solving an approximated dynamic programming. As previously described above with respect to a single demand type, consider Bellman operators at s=1, . . . ,T,

$${v}_{s}^{*} ( {x}_{s} ) = {H}_{s + 1} ( {v}_{s + 1}^{*} ) ( {x}_{s} ) := {inf}_{{u}_{s} ∈ Γ ( {x}_{s} )} {c}_{s} ( {x}_{s} , {u}_{s} ) + 𝔼 [ {v}_{s + 1}^{*} ( f ( {x}_{s} , {u}_{s} , {W}_{s} , {d}_{s + 1} ) ) ] , \qquad ( 9 )$$

where v_{T+1}* (x_{T+1})≡0. Here, with slight abuse of notation, we let cₛ be a general bounded Lipschitz continuous cost function at time s, and Γ be a Lipschitz continuous correspondence. We also remove the superscripts r,f here to indicate that this algorithm can be used for any stochastic dynamic program.

Let [symbol] _{b}( [symbol] ₛ) denote the space of continuous and bounded functions over [symbol] ₛ endowed with the supremum norm. To solve (9), we again use the empirical Bellman operator \tilde{H}ₛ₊₁^{k}: [symbol] _{b}( [symbol] ₛ)→ [symbol] _{b}( [symbol] ₛ) to approximate the actual Bellman operator Hₛ₊₁. Let {W_{s,i}}ᵢ₌₁^{k} be a sequence of independent identically distributed (i.i,d.) samples of wₛ, then the empirical Bellman operator Ĥₛ₊₁^{k} is given by

$${\hat{v}}_{s}^{k} ( {x}_{s} ) = {\hat{H}}_{s + 1}^{k} ( {\hat{v}}_{s + 1}^{k} ) ( {x}_{s} ) := {inf}_{{u}_{s}^{r} ∈ Γ ( {x}_{s} )} {c}_{s} ( {x}_{s} , {u}_{s} ) + \frac{1}{k} {\sum }_{i = 1}^{k} {\hat{v}}_{s + 1}^{k} ( f ( {x}_{s} , {u}_{s} , {W}_{s , i} ) ) . \qquad ( 10 )$$

As before, the value approximator \hat{v}ₛ^{k} is stored by projecting it onto a feasible function approximating class, such as neural networks or reproducing kernel Hilbert space (RKHS), which is dense in [symbol] _{b}( [symbol] ₛ). Let [symbol] _{d}( [symbol] ₛ)⊂ [symbol] _{b}( [symbol] ₛ) be the function approximating class parameterized by d∈ [symbol] . We then create a data set {x_{s,j}, \hat{v}ₛ^{k}(x_{s,j})}ⱼ₌₁^{k}′, where {x_{s,j}}ⱼ₌₁^{k′} are uniformly sampled from the state space [symbol] ₛ, and \hat{v}ₛ^{k}(x_{s,j}) is obtained according to (10). We let Πₛ^{k′,d}: [symbol] _{b}( [symbol] ₛ)→ [symbol] _{d}( [symbol] ₛ) be the function approximating the projection that maps the output of Ĥₛ₊₁^{k}(\hat{v}ₛ₊₁^{k}) to a function in [symbol] _{d}. This is defined as

$${\prod }_{s}^{l , d} ( {\hat{v}}_{s}^{k} ) = arg {inf}_{h ∈ {𝒢}_{d}} Loss ( {\hat{v}}_{s}^{k} , h \vert {\{ {x}_{s , j} \}}_{j = 1}^{k ′} ) , \qquad ( 11 )$$

where the loss function Loss: [symbol] _{b}( [symbol] ₛ)× [symbol] _{d}( [symbol] ₛ)→ [symbol] ₊ can be picked as the mean squared error between two functions

$$Loss ( {\hat{v}}_{s}^{k} , h \vert {\{ {x}_{s , j} \}}_{j = 1}^{k ′} ) = \frac{1}{{k}^{′}} {\sum }_{j = 1}^{k ′} {( {\hat{v}}_{s}^{k} ( {x}_{s , j} ) - h ( {x}_{s , j} ) )}^{2} .$$

We again construct a composite operator that combines the empirical Bellman operator and function approximating operator. We obtain an approximate function \hat{v}ₛ by replacing the actual Bellman operator Hₛ₊₁ with a random fitted empirical Bellman operator Ψₛ^{k,k′,d} which is given by

Ψₛ^{k,k′,d}=Πₛ^{k′,d}∘Ĥₛ₊₁^{k}: [symbol] _{d}( [symbol] ₛ₊₁)→ [symbol] _{d}( [symbol] ₛ).

Here, k is the number of samples generated, d is a parameter describing the size of the function approximating class, and k′ is the number of samples used in computing the empirical loss function for the projection operation. By increasing k, k′, d simultaneously, we let j∈ [symbol] and k(j), k′(j), d(j) be such that as j→∞, we have k(j), k′(j), d(j)→∞. In this case, the fitted value iteration algorithm is given by

$${\hat{v}}_{s}^{j} ( {x}_{s} ) = {Ψ}_{s}^{j} ( {\hat{v}}_{s + 1}^{j} ) ( {x}_{s} ) := {Ψ}_{s}^{k ( j ) , k ′ ( j ) , d ( j )} ( {\hat{v}}_{s + 1}^{k ( j ) , k ′ ( j ) , d ( j )} ) ( {x}_{s} ) . \qquad ( 12 )$$

The convergence of \hat{v}ₛ^{j} is proven in Theorem 1 as previously described.

Lemma 3. If Assumption 1 holds, then \hat{v}ₛ^{j} is satisfied for any κ>0,

$${limsup}_{j \to ∞} ℙ ( {‖ {\hat{v}}_{s}^{j} - {v}_{s}^{*} ‖}_{∞} > κ ) = 0.$$

Note that the convergence result is established under j→∞, which means that computing \hat{v}ₛ^{j} with small error K requires a sufficiently large number of samples k(j). However, if we apply (12) on the problem (8), then it becomes practically intractable with multiple types of demand, e.g. reliable (inflexible) and flexible demand. As previously described, the dimensionality of the action space is dim( [symbol] ₛ)=dim( [symbol] ₛ^{r})+Σₗ₌₁^{L} dim ( [symbol] ₛ^{f/l}), which increases linearly with L. This can be shown to leads to the computation complexity of solving the optimization (8) of at least O(L²). Further, the state space dimensionality is also linearly increasing with L, e.g. dim( [symbol] ₛ)=dim( [symbol] ₛ^{r})+Σₗ₌₁^{L} dim ( [symbol] ₛ^{f,l}), which also leads to high sample and computational complexity. The quadratic scaling of computational time in the size of the state and action spaces is addressed by dividing the scheduling problem into two subproblems in which the state and action space of each subproblem is smaller. This reduces the computational time at the expense of a small loss in optimality. However, we also identify a sufficient condition under which there is no loss in optimality.

### Reducing Complexity Through Two Stages of Scheduling

In this section, we describe a two stage algorithm that sequentially solves (7) according to each type of demand. This can reduce the dimensionality of the state space [symbol] ₛ^{r}× [symbol] ₛ^{f}, which simplifies the empirical fitted value iteration.

The Bellman equation (8) is decoupled as follows: we separate the state space [symbol] ₛ into [symbol] ₛ^{r} and [symbol] ₛ^{f,1}, . . . , [symbol] ₛ^{f,L}, and consider a sub-scheduling problem on each separated space. That is, we sequentially solve the original problem based on the types of demands, where each stage solves an empirical fitted value iteration on [symbol] ₛ^{r}, [symbol] ₛ^{f,1}, . . . , [symbol] ₛ^{f,L} iteratively. Though this may seem like an intuitive decoupling, the key challenge here comes from the control variables uₛ^{r} and uₛ^{f,1}, . . . , uₛ^{f,L} sharing the same bounds dₛ in the last inequalities of (6). Recognizing this forms our motivation to obtain dₛ^{r} and dₛ^{f,1}, . . . , dₛ^{f,L} sequentially for satisfying (4) as described below.

### Reliable Demand

We first let dₛ^{r}=dₛ, which implies that the reliable demand consumes all the electricity available to the platform. Then, the reliable demand is scheduled by solving the Bellman equation (9) for reliable demand only. For instance, we let

$${π}_{s}^{r} ( {x}_{s}^{r} ) = {arginf}_{{u}_{s}^{r} ∈ {Γ}^{r} ( {x}_{s}^{r} )} {c}_{s}^{{r}^{T}} {u}_{s}^{r} + 𝔼 [ {v}_{s + 1}^{r *} ( {f}^{r} ( {x}_{s}^{r} , {u}_{s}^{r} , {W}_{s}^{r} ) ) ] , \qquad ( 13 )$$

where vₛ^{r+}: [symbol] ₛ^{r}→ [symbol] is the optimal value function for the cost of reliable demand only. Here, we use the empirical fitted value iteration to solve (13) to obtain the approximated value function \hat{v}ₛ^{r,j}. The approximated optimal control action at each time s is ûₛ^{r}*=\hat{π}ₛ^{r,j}(xₛ^{r}), where \hat{π}ₛ^{r,j} is the approximated scheduling policy corresponding to \hat{v}ₛ^{r,j}. Then, the expected total cost based on the given initial state x^{r} is

$${J}^{r} [ {\hat{π}}^{r , j} ; {x}^{r} ) = 𝔼 [ {\sum }_{s = 1}^{T} {c}_{s}^{{r}^{T}} {\hat{u}}_{s}^{r *} \vert {x}_{0}^{r} = {x}^{r} ] .$$

### Flexible Demand

Similarly to the reliable demand, the flexible demand with minimum demand l is scheduled by the policy

$${π}_{s}^{f , l} ( {x}_{s}^{f , l} ) = {arginf}_{{u}_{s}^{f , l} ∈ {Γ}^{f , l} ( {x}_{s}^{f , l} )} {c}_{s}^{f , {l}^{T}} {u}_{s}^{f , l} + {{p}_{s}^{f , {l}^{T}} ( {z}_{s}^{f , l} - {u}_{s}^{f , l} )}_{( t , m , n ) ∈ {𝒥}_{s , 1}^{f , l}}^{+} + 𝔼 [ {v}_{s + 1}^{s , l *} ( {f}^{f , l} ( {x}_{s}^{f , l} , {u}_{s}^{f , l} , {W}_{s}^{f , l} ) ) ] , \qquad ( 14 )$$

where vₛ^{f,l}: [symbol] ₛ^{f/l}→ [symbol] is the optimal value function for flexible demand only. In this case, we denote \hat{v}ₛ^{f,l} as the approximator for vₛ^{f,l} by using the empirical fitted value iteration (12). We then obtain \hat{π}ₛ^{f,l,j}(xₛ^{f,l}) as the corresponding approximated optimal policy.

However, we need to use the optimal action ûₛ^{r}* to compute the remaining electricity that can be allocated to the flexible demand. That is, we compute the dₛ^{f,l} by

$${\underline{d}}_{s}^{f , l} = {( {\underline{d}}_{s} - {1}^{T} {\hat{u}}_{s}^{r *} - {\sum }_{i = 1}^{L} {1}^{T} {\hat{u}}_{s}^{f , i *} )}^{+} , \\ {\overline{d}}_{s}^{f , l} = {( {\overline{d}}_{s} - {1}^{T} {\hat{u}}_{s}^{r *} - {\sum }_{i = 1}^{L} {1}^{T} {\hat{u}}_{s}^{f , i *} )}^{+} , \qquad ( 15 )$$

where ûₛ^{f,l}*=\hat{π}ₛ^{f,l,j}(xₛ^{f,l}) the approximated optimal action for the flexible demand with minimum demand l.

Here, it is straightforward to verify that computing dₛ^{f,l} with 15 for each l=1, . . . , L yields dₛ^{r}, dₛ^{f,1}, . . . , dₛ^{f,L} satisfying (4). In this case, the optimal expected total cost for flexible demand is given by

$${J}^{f , l} ( {\hat{π}}^{f , l , j} ; {x}^{f , l} ) = 𝔼 [ {\sum }_{s = 1}^{T} ( {c}_{s}^{f , {l}^{T}} {\hat{u}}_{s}^{f , l *} + {{p}_{s}^{f , {l}^{T}} ( l - {\sum }_{τ = t}^{s} {\hat{u}}_{s}^{f , l *} )}_{( t , m , n , l ) ∈ {𝒥}_{s , 1}^{f , l}}^{+} \vert {x}_{0}^{f , l} = {x}^{f , l} ] .$$

We establish the following sufficient condition to guarantee the optimality of the above decoupling procedure.

Lemma 4. Suppose d₁, . . . , d_{T} satisfy for all s=1, . . . , T,

dₛ=0,d̅ₛ≥r( [symbol] ^{T}yₛ^{r}+Σₗ₌₁^{L} [symbol] ^{T}yₛ^{f,l}) (16)

then for any κ>0,

$${limsup}_{j \to ∞} ℙ ( \vert {J}^{r} ( {\hat{π}}^{r , j} ; {x}^{r} ) + {\sum }_{l = 1}^{L} {J}^{f , l} ( {\hat{π}}^{f , l , j} ; {x}^{f , l} ) - J ( π ; x ) \vert \geq κ ) = 0.$$

Proof. We will first show that if (16) holds, then uₛ^{r}*=πₛ^{r}(xₛ^{r}) and uₛ^{f,l}*=πₛ^{r}(xₛ^{f,l}) for l=1, . . . , L will minimize (8). Then we apply triangular inequality to prove the probability bounds. The feasible action set of (8) defined in (6) yields that for any (uₛ^{r}, uₛ^{f})∈Γ(xₛ^{r}, xₛ^{f}), we have uₛ^{r}∈Γ^{r}(xₛ^{r}) and uₛ^{f,l}∈Γ^{f,l}(xₛ^{f,l}). Thus,

0≤uₛ^{r}≤g(xₛ^{r})=min{ryₛ^{r},z^{r}}≤ryₛ^{r},

0≤uₛ^{f,l}≤g(xₛ^{f,l})=min{ryₛ^{f,l}*,z^{f,l}*}≤ryₛ^{f,l},

by (2) and (3). That is, if (16) holds, then

$${\underline{d}}_{s} = 0 \leq {1}^{T} {u}_{s}^{r} + {\sum }_{l = 1}^{L} {1}^{T} {u}_{s}^{f , l} \leq r ( {1}^{T} {y}_{s}^{r} + {\sum }_{l = 1}^{L} {1}^{T} {y}_{s}^{f , l} ) \leq {\overline{d}}_{s} , for all s = 1 , … , T ,$$

which implies

$${Γ}^{r} ( {x}_{s}^{r} ) ⊂ \{ {u}_{s}^{r} ∈ {𝒰}_{s}^{r} : {\underline{d}}_{s} \leq {1}^{T} {u}_{s}^{r} + {\sum }_{l = 1}^{L} {1}^{T} {u}_{s}^{f , l} \leq {\overline{d}}_{s} , {u}_{s}^{f , l} ∈ {Γ}^{f , l} ( {x}_{s}^{f , l} ) , for all l = 1 , … , L \} , \\ {Γ}^{f , l} ( {x}_{s}^{f , l} ) ⊂ \{ {u}_{s}^{f , l} ∈ {𝒰}_{s}^{f , l} : {\underline{d}}_{s} \leq {1}^{T} {u}_{s}^{r} + {\sum }_{l ′ = 1}^{L} {1}^{T} {u}_{s}^{f , l ′} \leq {\overline{d}}_{s} , {u}_{s}^{r} ∈ {Γ}^{r} ( {x}_{s}^{r} ) , {u}_{s}^{f , l} ∈ {Γ}^{f , l} ( {x}_{s}^{f , l} ) , for all {l}^{′} = 1 , … , L , {l}^{′} \neq l \} .$$

Thus, we can conclude that (16) implies

Γ(xₛ^{r},xₛ^{r})={(uₛ^{r},uₛ^{f})∈ [symbol] ₛ^{r}× [symbol] ₛ^{f}:

uₛ^{r}∈Γ^{r}(xₛ^{r}),uₛ^{f,l}∈Γ^{f,l}(xₛ^{f,l}), for all l=1, . . . ,L}.

By applying the principle of mathematical induction from s=T to s=1 with v_{T}*, v_{T}^{r}*, v_{T}^{f,l}*≡0, we have (8) being equivalent to

$${v}_{s}^{*} ( {x}_{s} ) = {inf}_{{u}_{s}^{r} ∈ Γ ( {x}_{s}^{r} ) , {u}_{s}^{f , l} ∈ Γ ( {x}_{s}^{f , l} ) , l = 1 , … , L} {c}_{s}^{{r}^{T}} {u}_{s}^{r} + {\sum }_{l = 1}^{L} ( {c}_{s}^{f , {l}^{T}} {u}_{s}^{f , l} + {{p}_{s}^{f , {l}^{T}} ( {z}_{`s}^{f , l} - {u}_{s}^{f , l} )}_{( t , m , n ) ∈ {𝒥`}_{s , 1}^{f , l}}^{+} ) + 𝔼 [ {v}_{s + 1}^{*} ( f ( {x}_{s} , {u}_{s} , {W}_{s} , {d}_{s + 1} ) ) ] = {v}_{s}^{r *} ( {x}_{s}^{r} ) + {\sum }_{l = 1}^{L} {v}_{s}^{f , l *} ( {x}_{s}^{f , l} ) , for all s = 1 , … , T .$$

This indicates that given (16), if uₛ^{r}*=π^{r}(xₛ^{r}) and uₛ^{f,l}*=π^{f,l}(xₛ^{f,l}) for l=1, . . . , L, then (uₛ^{r}*, uₛ^{f,l}*, . . . ,uₛ^{f,l}*) minimizes (8).

We now prove the probability bounds. By Lemma 3, we have for any κ>0,

$$\begin{matrix}0 = {limsup}_{j \to ∞} ℙ ( {‖ {\hat{v}}_{s}^{r , j} - {v}_{s}^{r *} ‖}_{∞} > κ ) \\ = {limsup}_{j \to ∞} ℙ ( {‖ {v}_{s}^{f , l , j *} - {v}_{s}^{f , l} ‖}_{∞} > κ ) .\end{matrix}$$

That is, for any x=(x^{r}, x^{f,l}, . . . , x^{f,L})∈ [symbol] ₀^{r}× [symbol] ₀^{f} and κ>0,

$${limsup}_{j \to ∞} ℙ ( \vert {J}^{r} ( {\hat{π}}^{r , j} ; {x}^{r} ) + {\sum }_{l = 1}^{L} {J}^{f , l} ( {\hat{π}}^{f , l , j} ; {x}^{f , l} ) - J ( π ; x ) \vert \geq κ ) = {limsup}_{j \to ∞} ℙ ( \vert {J}^{r} ( {\hat{π}}^{r , j} ; {x}^{r} ) + {\sum }_{l = 1}^{L} {J}^{f , l} ( {\hat{π}}^{f , l , j} ' {x}^{f , l} ) - {v}_{0}^{r *} ( {x}^{r} ) - {\sum }_{l = 1}^{L} {v}_{0}^{f , l *} ( {x}^{f , l} ) \vert \geq κ ) \leq {limsup}_{j \to ∞} ℙ ( \vert {J}^{r} ( {\hat{π}}^{r , j} ; {x}^{r} ) - {v}_{0}^{r *} ( {x}^{r} ) \vert \geq κ ) + {\sum }_{l = 1}^{L} {limsup}_{j \to ∞} ℙ ( \vert {J}^{f , l} ( {\hat{π}}^{f , l , j} ; {x}^{f , l} ) - {v}_{0}^{f , l *} ( {x}^{f , l} ) \vert \geq κ ) \leq {limsup}_{j \to ∞} ℙ ( {‖ {\hat{v}}_{0}^{r , j} - {v}_{0}^{r *} ‖}_{∞} > κ ) + {\sum }_{l = 1}^{L} {limsup}_{j \to ∞} ℙ ( {‖ {\hat{v}}_{0}^{f , l , j *} - {v}_{0}^{f , l *} ‖}_{∞} > κ ) = 0 ,$$

which completes the proof.

### Algorithm

Having computed the value functions using the fitted value iteration algorithm described above, we provide a detailed ADP algorithm to obtain u₀*, u₁*, . . . , u_{T}*. We compute the approximate optimal action for reliable and flexible demand as ûₛ^{r}* and ûₛ^{f,1}*, . . . , uₛ^{f,L}* using a multistage Rollout algorithm. Then, each EV in the category can be charged according to any disaggregation algorithm, like first-come, first served (FCFS). The overall algorithm is described below.

A coarse approximation of the true computational complexity of the algorithm may be provided as follows. Let U=max{dim( [symbol] ₛ^{r}), dim( [symbol] ₛ^{f,1}), . . . , dim( [symbol] ₛ^{f,L})}, then the time complexity of solving a linear optimization with constraints is (indeed, at least) O((L+1)²U^{2.5}). By using the two-stage algorithm according to the present disclosure, solving each stage is of time complexity of at least O(U^{2.5}) and the total time complexity is at least O((L+1)U^{2.5}).

The multi-stage EV charging scheduling and control algorithm according to embodiments of the disclosure may be summarized by the following pseudocode:

```
Part I: Multistage Fitted Value Iteration
  Initialize v_{T+1}*≡ 0.
  FOR s = T, . . ., 1 DO
      Generate state and noise samples for reliable demand: {x_{s,j}^{r}}ⱼ₌₁^{k}′ and {W_{s,i}^{r}}ᵢ₌₁^{k}
      Create data set using fitted empirical Bellman operator {x_{s,j}^{r}, \hat{v}ₛ^{r,j} (x_{s,j})}ⱼ₌₁^{k}′, and
        obtain vₛ^{r,j} with Neural networks.
      Generate state and noise samples for flexible demand {x_{s,j}^{f,l}}ⱼ₌₁^{k}′ and {W_{s,i}^{f,l}}ᵢ₌₁^{k} for
        each l = 1, ..., L. Create data set using fitted empirical Bellman operator
        {x_{s,j}^{f,l}, \hat{v}ₛ^{f,l,j} (x_{s,j})}ⱼ₌₁^{k}′, and obtain \hat{v}ₛ^{f,l,j} with Neural networks for each l = 1, .., L.
  END FOR
Part II: Multistage Rollout Algorithm
  Initialize x₀ = 0.
  FOR s = 1, . . ., T DO
      Update xₛ using (5), and decouple xₛ into xₛ^{r}, xₛ^{f,1}, ..., xₛ^{f,L}.
      Pick dₛ^{r} = dₛ and compute ûₛ^{r}* = \hat{π}ₛ^{r}(xₛ^{r}) by (13).
    FOR l = 1, ...., L DO
      Update dₛ^{f,l} by (15).
      Compute ûₛ^{f,l}* = \hat{π}ₛ(xₛ^{r}) with (14).
    END FOR
    FOR (t,m,n) ∈ T × B^{r} and (t,m,n,l) ∈ T × B^{f} DO
      Charge each EV η units of electricity in the interval from s to s + 1 based on FCFS
        discipline, where:
        IF In category (t,m,n) THEN
          Reliable demand: η = ûₛ^{t,m,n}* /yₛ^{t,m,n}
        ELSE
          Flexible demand: η = ûₛ^{t,m,n,l}* /yₛ^{t,m,n,l}
        END IF
    END FOR
  END FOR
```

### Numerical Results

### Simulation Setup

In this illustration of operation of the system or method for scheduling and controlling EV charging based on the scheduling of a large number of EVs, we consider the scheduling of EV charging for a T=24 hour period, that is, from 7 AM (day 1) to 7 AM (day 2). The electricity prices may vary according to a time-of-use schedule having two or more ranges or categories as well as the day of the week (such as weekdays/weekends) and a summer/winter season, for example. In this illustration, electricity prices vary according to peak/off-peak hours during the same season and days with the same rate (weekdays). We consider two types of customers, i.e. L=1, and the customers pay a constant price of 9.2¢/kWh for reliable demand and 7.36¢/kWh (20% discount) for flexible demand. The cost cₛ is considered as the difference between the electricity price and the revenue per kWh from the customers. The platform will compensate pₛ=2.5¢/kWh to customers if their minimum flexible demand is not met. In what follows, we will interpret the respective costs associated with reliable demand and flexible demand cₛ^{r} and cₛ^{f,l} as negative profits instead. These parameters are shown in Table 1 below:

TABLE 1
Electricity Prices During Weekdays

| Time (h) | 7-14 | 14-18 | 18-22 | 22-7 |
|---|---|---|---|---|
| Peak hours | Mid-Peak | On-Peak | Mid-Peak | Off Peak |
| cₛ^{r} ¢/kWh | 0 | 7.4 | 0 | −4.4 |
| cₛ^{f,1} ¢/kWh | 1.84 | 9.24 | 1.84 | −2.56 |
| pₛ^{f,1} ¢/kWh | 2.5 | 2.5 | 2.5 | 2.5 |

For this example, we choose M=3 and N=6, and the charging rate is fixed at r=10 kW. The feasible menus [symbol] ^{r} and [symbol] ^{f,1} are given in Table 2 below. Then, the dimensionality of the state/action space is determined, which is dim( [symbol] ₛ^{r})=182, dim( [symbol] ₛ^{f,1})=272 and dim( [symbol] ₛ^{r})=dim( [symbol] ₛ^{f,1})=90. The arrival process {wₜ^{r} [symbol] and {wₜ^{f,1} [symbol] are sequences of random variables with Poisson distribution. The distribution of the arrival process is deduced from the ACN Dataset. We also pick dₛ=[0 kWh, 10000 kWh] as the hourly grid bounds.

TABLE 2
Feasible Menu Given M = 3 And N = 6

| B^{r}, B^{f, 1} | n = 1 | n = 2 | n = 3 | n = 4 | n = 5 | n = 6 |
|---|---|---|---|---|---|---|
| m = 10 kWh | (1, 1) | (1, 2) | (1, 3) | (1, 4) | (1, 5) | (1, 6) |
| m = 20 kWh | x | (2, 2) | (2, 3) | (2, 4) | (2, 5) | (2, 6) |
| m = 30 kWh | x | x | (3, 3) | (3, 4) | (3, 5) | (3, 6) |

For the projection operator, we choose the number of state samples and noise samples to be 64 (i.e. j=64). The function approximating class [symbol] _{d} is the set of neural networks with width dim( [symbol] ₛ^{r})×2=364 and dim( [symbol] ₛ^{f,1})×2=544 and depth 8. The learning rate is chosen as 0.005. The empirical fitted value iteration is employed to compute the value functions \hat{v}ₛ^{r,j} and \hat{v}ₛ^{f,1,j}.

### Results of Reliable and Flexible Demand

We demonstrate the performance of our ADP algorithm, denoted as ADP, by comparing it with two other algorithms: SP (simple programming) and FCFS (first-come first-serve). The algorithm SP computes the optimal cost with the knowledge of all the future demand—in this case, the problem boils down to solving a linear program with constraints. It is formulated by a deterministic optimization problem since {wₜ^{T} [symbol] , {wₜ^{f,1}} [symbol] are known. We denote the optimal actions of SP as {u_{SP,s}^{r}* [symbol] and {u_{SP,s}^{r}* [symbol] . The second algorithm FCFS follows the First Come First Serve discipline, which charges the EVs immediately when they arrive at the charging station. This is the most widely used scheduling algorithm across the world. Let the actions of FCFS be denoted by {u_{FCFS,s}^{r}* [symbol] and {u_{FCFS,s}^{f,1}* [symbol] . An overview of the information required by the three algorithms is summarized in Table 3 below.

TABLE 3
Application Scenarios of the Algorithms
Given Knowledge of the Future

| Algorithms | Future Demand | Demand Distribution | No Knowledge |
|---|---|---|---|
| SP | Yes | No | No |
| ADP | Yes | Yes | No |
| FCFS | Yes | Yes | Yes |

We similarly denote optimal actions of our ADP algorithm as {u_{ADP,s}^{r}* [symbol] and {u_{ADP,s}^{f,1}* [symbol] . Let the cumulative cost for each sample path as

$${J}_{α , t}^{*} = {\sum }_{s = 1}^{T} ( {c}_{s}^{{r}^{T}} {u}_{α , s}^{r *} + {{p}_{s}^{{r}^{T}} ( m - {\sum }_{τ = t}^{s} {u}_{α , s}^{r *} )}_{( t , m , n ) ∈ {𝒥}_{s , 1}^{r}}^{+} + {c}_{s}^{f , {l}^{T}} {u}_{α , s}^{f , l *} + {{p}_{s}^{f , {l}^{T}} ( l - {\sum }_{τ = t}^{s} {u}_{α , s}^{f , l *} )}_{( t , m , n , l ) ∈ {𝒥`}_{s , 1}^{f , l}}^{+} ) \qquad ( 17 )$$

where α∈{ADP,SP,FCFS}. Note that J_{SP}* are the lower bounds on J_{ADP}* and J_{FCFS}* since it knows all the future demand. Ten sample paths are used to compare the performance of these algorithms, and the results are shown in FIG. 2. Since ADP and SP exploit knowledge of the future demand distribution or demand itself, their profits are much higher than the FCFS charging policy. We consider two types of FCFS for flexible demand: charge the EV up to the minimum target or the maximum target SOC.

We can further observe from FIG. 2 that despite FCFS with maximum demand, all of the algorithms serve a similar amount of demand at the end of the day. In fact, ADP serves more demand, and achieves a relatively similar profit to SP. The optimality gap between SP and ADP in the upper plot of FIG. 2 is due to the approximation error of the value function and the uncertainty about the future in the ADP algorithm.

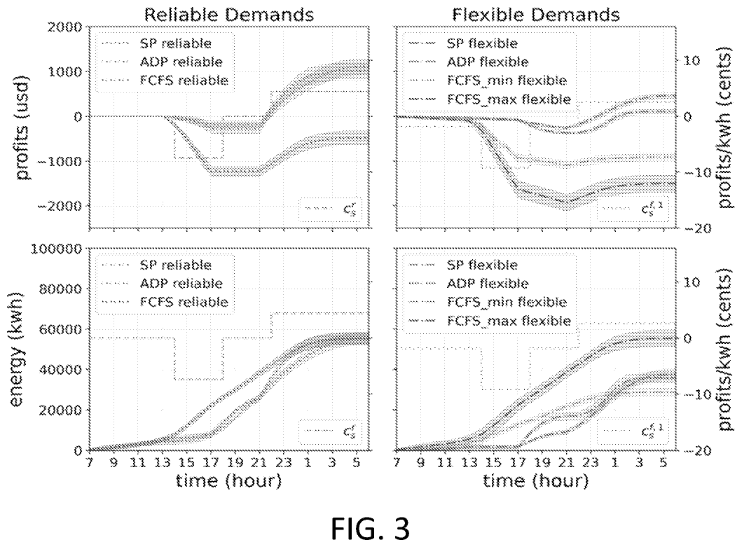

FIG. 3 depicts that the error from the approximation in the flexible demand setting. This results from two major facts in serving flexible demand: 1) the value function is more difficult to approximate due to the penalty term in the cost function; 2) the two-stage optimization makes the value function of flexible demand more sensitive to the results of the reliable demand optimization, and the function approximator requires more data samples to achieve the comparable accuracy. Under the reliable demand setting, the profits of SP and ADP are similar, whereas, under the flexible setting, there is an optimality gap between SP and ADP. However, ADP performs better than FCFS for both settings.

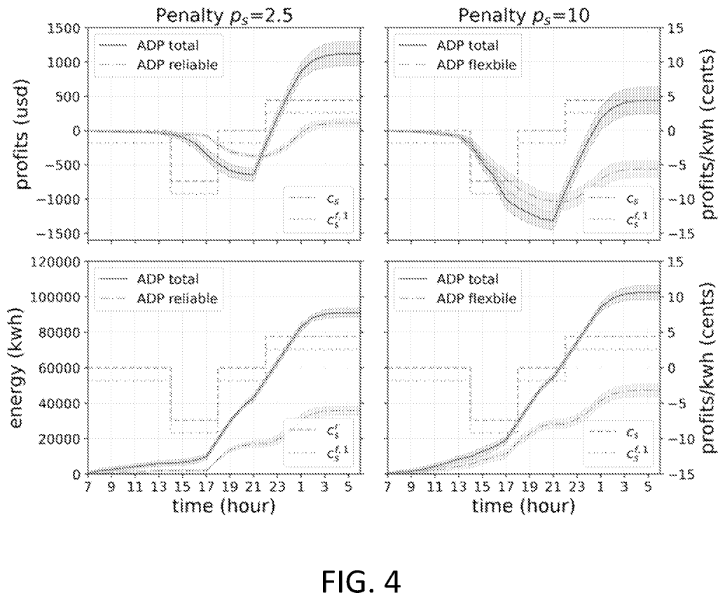

We also observe that the penalty of violating the charging demand can significantly affect the profits in the flexible demand setting, which is shown in FIG. 4. A lower penalty leads to lower energy consumption but higher profits since it allows dropping flexible demand during the peak hours.

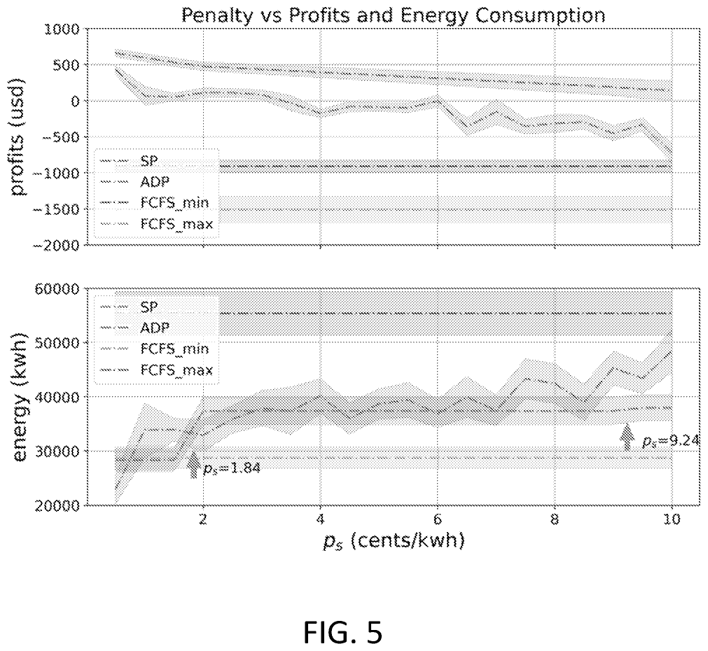

As the penalty pₛ^{f,l} increases, the optimality gap between SP and ADP becomes larger, as demonstrated in FIG. 5. Here, the FCFS algorithm is not affected by the penalty changes. Note that at pₛ^{f,1}=1.84 and pₛ^{f,1}=9.24, the SP energy consumption increases due to the penalty being higher than the charging cost during the mid-peak and peak hours respectively, and the demand with high charging cost cannot be dropped. This leads to a trade-off between the total charge provided and the cumulative profits.

### Constraints Relaxation for Reliable Demand

As long as the grid bounds dₛ are sufficiently large, the reliable demand can always be fully satisfied. However, in various regions and/or during various times, the available grid power may be limited to less than the reliable demand. In this case with limited grid bounds dₛ, leads to Γ^{r}(xₛ^{r})=Ø, and thus, there is no feasible solution for (13). To circumvent this, we also add a penalty term to the reliable demand setting. It solves the following Bellman equation

$${π}_{s}^{r} ( {x}_{s}^{r} ) = {arginf}_{{u}_{s}^{r} ∈ {Γ}^{r ′} ( {x}_{s}^{r} )} {c}_{s}^{{r}^{T}} {u}_{s}^{r} + {{p}_{s}^{{r}^{T}} ( {z}_{s}^{r} - \underbrace{{u}_{s}^{r}}_{penalty for reliable demand} )}_{( t , m , n ) ∈ {𝒥`}_{s , 1}^{r}}^{+} + 𝔼 [ {v}_{s + 1}^{r *} ( {f}^{r} ( {x}_{s}^{r} , {u}_{s}^{r} , {W}_{s}^{r} ) ) ] , \qquad ( 18 )$$

where Γ^{r}′ is the relaxed feasible action set, i.e.

Γ^{r}′(xₛ^{r}):={uₛ^{r}∈ [symbol] ₛ^{r}:0≤uₛ^{r}≤g(xₛ^{r}),dₛ^{r}≤ [symbol] ^{T}uₛ^{r}≤d̅ₛ^{r}},

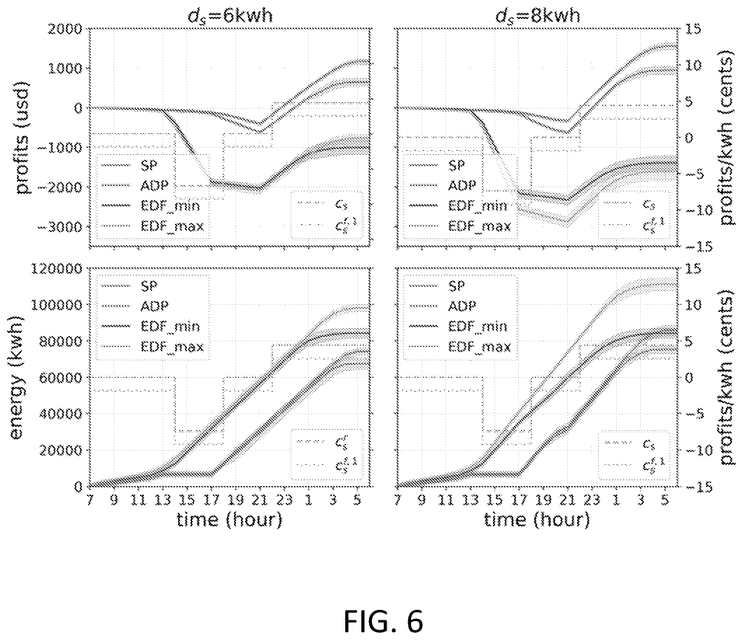

and vₛ^{r}′* is the corresponding value function. For this example, we choose dₛ=[0,6000 kWh] and dₛ=[0,8000 kWh] to demonstrate the performance of each algorithm in this scenario, which is shown in FIG. 5. In this case, we replace the principle of heuristic algorithm from FCFS to EDF since EDF requires smaller grid bounds to meet the charging demand. The results are depicted in FIG. 6. During the peak hours, SP and ADP consume 0 kWh electricity since the demand is not served and the platform pays penalties to the customers—this leads to SP and ADP having a higher profit than EDF. In the context of FIG. 6, we can observe that the optimality gap between SP and ADP caused by the multi-stage algorithm reduces if the grid bound is sufficiently large (dₛ=10 kWh). This was established in Lemma 4.

As described herein, scheduling of EV charging may be modeled with multiple types of reliability constraint as a stochastic dynamic program. Due to very high dimensional state and action spaces, and a high number of constraints, the resulting problem could not be solved using the usual dynamic programming algorithm. As such, various embodiments according to the disclosure use fitted value iteration to solve the problem, and apply a multi-stage algorithm to reduce the computational complexity of the solution approach. Simulations show that this algorithm yields profits close to optimal profits under full information about the future demand of the EVs, and is better than the heuristic algorithms like FCFS and EDF. This disclosure demonstrates robustness of the algorithm with relaxed constraints in optimization. While the disclosed two-stage decoupling algorithm may provide acceptable results for various applications, it may be further improved to reduce the optimality gap.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for controlling charging of multiple electric vehicles (EVs) arriving at, and departing from, different charging stations at different times, comprising, by one or more processors:
scheduling charging of each EV of the multiple EVs responsive to which one of a plurality of categories each EV is assigned, each EV assigned to one of the categories according to an arrival time at an associated one of the different charging stations, a departure time from the associated one of the different charging stations, an initial state of charge (SoC) of the EV, and a target SoC of the EV; and
controlling charging of each EV responsive to the scheduling of charging for the assigned category of each EV.

2. The method of claim 1 further comprising assigning each EV to one of the categories according to one of a plurality of charging demand types designated by the EV.

3. The method of claim 2 wherein the plurality of charging demand types includes a reliable charging demand and a flexible charging demand.

4. The method of claim 3 wherein scheduling charging of each EV designating the flexible charging demand includes scheduling the charging responsive to a specified minimum target SoC and a specified maximum target SoC of the EV.

5. The method of claim 3 wherein scheduling charging of each EV comprises:
scheduling charging of EVs designating the reliable charging demand assuming the EVs designating the reliable charging demand will consume all available electricity during a specified time period based on an associated grid upper demand band for the specified period; and
scheduling charging of EVs designating the flexible charging demand based on the specified minimum target SoC of the EVs designated the flexible charging demand.

6. The method of claim 3 wherein scheduling charging of each EV comprises:
allocating available electricity from an electrical grid to each of the plurality of categories based on a number of EVs in each category arriving at the charging stations during a designated time period and a cost associated with allocated available electricity, the allocated available electricity limited by a minimum of remaining electricity available for each category and charging capacity of the multiple EVs.

7. The method of claim 6 wherein the cost associated with the allocated available electricity corresponds to a net cost corresponding to cost of electricity supplied by an electric grid less a cost associated with a penalty corresponding to the allocated available electricity corresponding to EVs designating the reliable charging demand being insufficient to charge the EVs designating the reliable charging demand to associated target SoCs.

8. The method of claim 6 wherein the cost associated with the allocated available electricity corresponds to a net cost corresponding to cost of electricity supplied by an electric grid less a cost associated with a penalty corresponding to the allocated available electricity corresponding to EVs designating the flexible charging demand being insufficient to charge the EVs designating the reliable charging demand to associated minimum target SoCs.

9. The method of claim 6 wherein scheduling charging of each EV comprises:
determining a number of EVs in each category designating a reliable charging demand and arriving at a specified time using a designated statistical distribution;
allocating electricity from the grid available for charging to each category designating the reliable charging demand for a second specified time period;
associating electricity cost of electricity allocated to each category designating a reliable charging demand; and
allocating any electricity available after satisfying the reliable charging demand for the second specified time period to EVs designating the flexible charging demand.

10. The method of claim 9 wherein scheduling charging of each EV further comprises limiting allocation of electricity from the grid available for charging to each category designating the reliable charging demand to a minimum of remaining electricity available from the grid and charging capacity of the EVs designating the reliable charging demand.

11. A computer-implemented method for controlling charging of a large number of electric vehicles (EVs) arriving and departing different charging stations at different times, the method comprising, by one or more computers:
assigning one of a plurality of categories to each EV that arrives at a charging station depending on arrival time to the charging station, designated departure time from the charging station, initial state of charge (SoC) of the EV, target SoC of the EV, and a charging demand type specified by the EV;
scheduling charging of each EV according to which of the plurality of categories the EV has been assigned and the charging type specified by the EV; and
controlling charging of each EV based on the scheduling.

12. The method of claim 11 wherein the demand type specified by the EV corresponds to a flexible demand type, wherein EVs specifying the flexible demand type specify a minimum target SoC and a maximum target SoC, and wherein controlling charging is based on the minimum target SoC and the maximum target SoC specified by the EV.

13. The method of claim 12 wherein, for categories associated with the flexible demand type, the scheduling is based on controlling the charging to satisfy the minimum target SoC for each EV specifying the flexible demand type, and continuing to charge to the maximum target SoC responsive to profit associated with charging to the maximum target SoC exceeding a threshold.

14. The method of claim 13 wherein the demand type includes a reliable demand type, and wherein scheduling charging comprises allocating electricity available from the grid to categories associated with the reliable demand type before allocating the electricity available from the grid to categories associated with the flexible demand type.

15. The method of claim 14 wherein scheduling comprises assigning a penalty cost for each EV specifying the flexible demand type that is not charged to at least the minimum target SoC prior to the departure time.

16. The method of claim 11 wherein the scheduling is based on a statistical distribution of arrival times to the charging stations and designated departure times from the charging stations.

17. A system comprising:
a plurality of electric vehicle (EV) charging stations each configured to charge a plugged EV during a time period specified by at least one remotely-located processor, the processor configured to schedule charging of EVs for all of the charging stations by scheduling a plurality of charging categories, each EV assigned to one of the plurality of categories by the processor based on arrival time to a charging station, expected departure time from the charging station, state of charge (SoC) of the EV upon arrival, target SoC of the EV before the expected departure time, and a charging demand type specified by the EV.

18. The system of claim 17 wherein each of the plurality of charging stations includes a processor configured to control charging of an associated plugged EV according to the charging schedule.

19. The system of claim 17 wherein the processor is configured to schedule charging of EVs based on a minimum and maximum available power provided from an associated electric grid.

20. The system of claim 17 wherein the charging demand type includes a flexible demand having an associated minimum target SoC and maximum target SoC specified by the EV, and wherein the processor is further configured to schedule charging of EVs to provide the minimum target SoC for all EVs specifying the flexible demand, and to continue charging the EVs specifying the flexible demand above the minimum target SoC only if an associated profit exceeds a threshold.
